(19) United States
(12) Patent Application Publication
(10) Pub. No.: US 2014/0019835 A1
(43) Pub. Date: Jan. 16, 2014

(54) Digital Book Provision System

(71) Applicant: Shigeyoshi Kakiuchi, Minoh-shi (JP)

(72) Inventor: Shigeyoshi Kakiuchi, Minoh-shi (JP)

(21) Appl. No.: 14/007,066

(22) PCT Filed: Mar. 26, 2012
(86) PCT No.: PCT/JP2012/057681

§ 371 Date: Sep. 24, 2013

(30) Foreign Application Priority Data
Mar. 31, 2011 (JP) 2011-079381
Mar. 12, 2012 (JP) 2012-054769

(51) Int. Cl. G06F 17/21

(52) U.S. Cl. CPC G06F 17/217
USPC 715/202

(57) ABSTRACT

When an image file which has a predetermined file format and is prepared as image data constituting the base of each page in a digital book is incoming to a server (2), a compatible image file (terminal-compatible image data) (AP, AA, AI) is generated and stored in each of a plurality of types of reading terminal devices (4P, 4A, 4I) which are to be read, and if a digital book reading request based on the image file is received from any of the terminal devices (4P, 4A, 4I), only an image file compatible with the type of the terminal device (4) is distributed and provided for display. As a result, a digital book provision system is provided which facilitates the creation of digital books that can be read by a plurality of types of reading terminal devices.

### BACKGROUND OF THE INVENTION

1. Technical Field

The invention relates to a digital book provision system for creating a digital book and, more specifically to, a digital book provision system for distributing the digital book.

2. Background Art

Recently, many digital contents have been distributed to various types of terminal devices of users and read there. The digital contents include e-books, namely digital books, which have been provided on paper so far. For example, Patent Document 1 discloses a technology for displaying a comic book as a digital content on a screen. Such digitization of books contributes to a decrease in emission of carbon dioxide, which is a target in the recent years, and is expected to be promoted further.

### DESCRIPTION OF THE RELATED ART

[Patent Document 1] Japanese Patent Application Laid-Open (JP-A) No. 2005-204338
[Patent Document 2] JP-A No. 2009-205319

### SUMMARY OF THE INVENTION

### Problems to be Solved by the Invention

However, presently, the digital book can be created only by requesting a specialty company to do so. In the case of requesting the specialty company to create a digital book, before its creation, a client and a producer need to discuss a lot about an overall plan of the book such as a layout and reading functions. Even after the book is created based on the discussion, further discussion for modifications and elaborations is necessary before the book is finished finally. Through the processes, the producer manually creates each of the books asked to meet those demands, to secure at least a certain quality.

Thus, presently, the heavy burden in creation of the digital book is placed on the producer side and added to a production cost to raise it and, finally, has to be shouldered by the client. Nonetheless, the user with little expertism cannot easily create the digital book on his/her own. If he does so, the resultant book might be of a degraded quality and too cheap to be a decent book. As a result, the book cannot be a content that can be easily read and attract many customers.

It is an object of the invention to provide a digital book provision system that enables even a layman to easily obtain a digital book having at least a certain quality.

### Means for Solving Problems and Effects of the Invention

To solve the problems, a digital book provision system of the invention

for creating and distributing a digital book whose pages are each displayed on a reading terminal device by an image file prepared for each page and in which keyword search can be performed on the basis of search-purpose character data which indicates a character string to be drawn by using the image files, the digital book provision system includes:

digital book creation means having: file acceptance means that accepts incoming one image file as an original image file, each page of the image file being displayed in a predetermined page frame and enablingforming images and character strings on it when the file is read by predetermined software, the page frame containing mutually correlated original image data to display the images and the character strings of each of the pages in the page frame and original character data to indicate the character strings of each of the pages to be displayed on the basis of the original image data, and page settings being made to both of the original image data and the original character data;

book basic data generation means that divides image data of each of the pages in accordance with the page settings contained in the one original image file whose incoming is accepted into page-specific image files, generates a page image file group in which those image files are correlated with page number information based on the page settings and character data which indicates character strings of each of the pages to be displayed by the page-specific image files, and displays drawn contents of each of the pages in the form of inheriting a display layout and the page settings in the page frame in each of the pages at the time when the original image data whose incoming is accepted is read and displayed with the software by the page-specific image files to be generated; and

digital book storage means that stores and accumulates in a predetermined digital book storage portion the generated page image file group assumed to be page display-purpose data in the digital book and the generated character data assumed to be the search-purpose character data in the digital book in the form of correlating the data with each other; and

digital book provision means having: reading request signal acquisition means that acquires a reading request signal for the digital books accumulated in the digital book storage portion via communication means; and

digital book distribution means that, if the reading request signal is acquired, reads the page display-purpose data and the search-purpose character data which are compatible with the reading request signal from the digital book storage portion and distributes the data to the reading terminal device from which the reading request signal is transmitted and also reads from a predetermined reading control program storage portion a reading control program which enables reading in page units the image files of all the pages contained in the page display-purpose data in accordance with the page settings in the original image file and then distributes this program.

There has been no concept or system of the invention so far for directly transforming display contents of original data (contents and page settings of each page) created by the producer into a digital book. According to the invention, original data created by the producer who is particular about an layout of images and characters in each page is transformed without changing their display contents into a high-function digital book that enables performing keyword search and page flipping-mode reading, so that the resultant book cannot be out of his intention. Patent Document 2 discloses a book for displaying only characters, and therefore, need not be particular about the layout of each page, so that even if some texts are carried over to the next page, it is of no problem; therefore, it is totally different technologically from the invention, which relates to a digital book using not only characters but also images. Therefore, it is impossible to easily conceive of the invention based on Patent Document 2. Further, it is impossible to conceive of the applied invention without the concept of the invention.

According to a configuration of the invention, if the incoming an original file created by the user by using predetermined software (for example, Word (note 1), Excel (note 1), or PowerPoint (note 1) of Microsoft Office (note 1)) is accepted, the original file is automatically transformed into a digital book that has at least keyword search functions. That is, it is possible to easily obtain a digital book having certain functions from an original file created with software in popular use.

Moreover, according to the invention, a digital book is automatically generated as a book in strict accordance with the page settings and page layout of an original file created by the user, so that it is possible to obtain a book having user-desired page contents in strict accordance with the original file. Further, a file that displays each page is prepared for each page, so that the invention is suitable for a digital book, which is assumed to be read in page units. In particular, in the case of a digital book subject to page transition in the page flipping mode, the invention is well suited for use in expression of, for example, page flipping, namely when another page is displayed through dynamic expression of page flipping in page to page transition. An animation (moving picture) expressing page flipping can be carried out in a simple way of defining a coordinate system compatible with the shape of a page in each process of page flipping and applying image data of the flipped page to each of the coordinate systems sequentially, so that if a page-specific image file is prepared, it is only necessary to perform processing to identify the image file of the flipped page and simply apply the image data to each of the coordinate systems which are sequentially switched.

Further, according to the configuration of the invention, not only the digital book automatically generated but also the system as a whole can be sold as a product. For example, it is also possible to utilize company document created by a user by using predetermined software capable of creating images (for example, Word (note 1), Excel (note 1), or PowerPoint (note 1) of Microsoft Office (note 1)) as a document management system that manages all the data in the shape of a digital book.

A name having (note 1) above is either a trademark or an article name and holds true also in the following.

Further, character data in the invention includes data such as symbols used on a regular basis of the society to express a language (ideographic characters, phonograms, logograms (lexigrams), syllabic characters, and monophonic characters or the like) and characters used to express numbers (Arabic numbers (“1”, “2”, etc.), Roman numbers (“,”) etc.), and Chinese numbers (“ [symbol] ”, “ [symbol] ”, etc.).

The book basic data generation means in the invention can be arranged such that original files created by a user by using predetermines software capable of creating images (for example, Word (note 1), Excel (note 1), or PowerPoint (note 1) of Microsoft Office (note 1)) confirmed to be able to be read by this software may be uniformly converted into a file having a predetermined format. In such a way, the following processing can all be performed by the same manner, and thus the overall processing may be simple and efficient irrespective of a difference in format of the incoming original files.

Further, these predetermined-format files to be converted uniformly are, for example, PDF files in which independent character data can be correlated with image data representing each page, so that by obtaining the predetermined-format file, a state can be provided in which page display-purpose image data and keyword search-purpose character data can be prepared respectively. Thus, it is possible to easily perform processing to separate and extract the image data and the character data in the following processing. The illustrated PDF file has and can search for both of the page display-purpose image data and keyword search-purpose character data and, therefore, facilitates separation and extraction of those image data and character data, being well suited for use as predetermined-format files to be uniformly converted.

Further, in a case where page display-purpose image data and keyword search-purpose character data are separated and extracted from a uniformly converted predetermined format-file, the page display-purpose image data is divided into page-specific image files. Thus, page display-purpose data (page image file group) suited as a digital book which assumes page-unit reading is generated.

In the invention, a plurality of groups with which at least one digital book group is correlated can be set and a registered user can belong to at least two of the groups, so that the user can set different authorities to the digital book group (group-use book group) compatible with those groups. That is, the authority to the digital book can be set in units of the digital book group belonging to the group. It is thus possible to create groups correlated with various digital book groups so that finally the registered user may belong to those groups, setting the same number of authorities as the number of the groups (the number of the digital book groups). That is, the authorities can be set without limitation.

Further, the groups include a group with which book information disclosure pages which display and disclose book information of correlated digital books are correlated, so that by updating the book information of this group, the update can be reflected also on the book information disclosure pages. It is thus possible to easily update the book information disclosure pages to be disclosed to the outside, for example, replace books to be displayed and change contents of the book information to be displayed.

Further, in a case where a registered user belonging to a group has created a new digital book, the created digital book can be made a group-use book group of the group to which the registered user belongs. Further, in a configuration in which a digital book creation authority is set for each group, the digital book newly created by the registered user can be correlated with only the group to which the digital book creation authority is set but not with all the groups to which the user belongs. In this case, the digital book creation authority can be effectively utilized not only as an authority to decide whether creation is permitted but also an authority to decide a group to which the created book belongs.

Further, the invention can provide a configuration in which data of a digital book corresponding to display on a plurality of terminal devices can be created from one piece of data that constitutes the base of the digital book. It is thus possible to eliminate the need for individually creating digital book data of each terminal device, mitigating the burdens on the side of the producer. Further, in this case, the digital book storage portion stores and accumulates dedicated book data for use only at each terminal device including terminal device-specific page image data and digital book data having character data compatible with the same page of each piece of the dedicated book data in condition where they are correlated with each other, for each digital book. It is thus possible to efficiently accumulate the digital books without storing the character data redundantly.

Further, in the configuration, the terminal types of the reading terminals are classified by a difference in reading terminal-specific predetermined standard of display images to be displayed on the screen, so that those standards are classified into various types by a difference in terminal shape and the operating system, a difference in manufacturer, and also a difference in product part number for each manufacturer. For example, the types are classified by differences in image size (either field angle or resolution or both of them) and image file format.

In the invention, the digital book creation means can be configured by including protruding region image exclusion means that excludes an image data portion protruding over a predetermined display range from a uniform post-conversion image file generated by file conversion means to provide image data in this display range. The inventors created many digital books experimentally from an original file by using the digital book creation means of the invention described above and, as a result, confirmed a problem peculiar to the digital book creation means of the invention of a possibility that when the file is uniformly converted into a uniform post-conversion image file and if data having an image data portion protruding over a display frame (display range) of the uniform post-conversion image file occurs as irregularities, an image file, if generated for each page, is created taking into account the protruding region also and unintentionally reduced in size as a whole. Therefore, to create a digital book in accordance with a digital book creation procedure of the invention, the protruding portion can be excluded at timing after the conversion into the uniform post-conversion image file such that the following processing can be performed smoothly. That is, the file is divided into page-specific image files in the following processing, and if the protruding portion is excluded after the division, processing is necessary to exclude the protruding portion independently for each file to increase processing burdens; however, if the protruding portion is excluded, before the division, the processing to exclude the protruding portion can be performed on all the pages collectively and carried out efficiently.

In the invention, the plurality of types of reading terminal devices have different image sizes (field angle and resolution) peculiar to each type, so that the terminal-compatible image data generation means can change image data extracted by the image data extraction means into a predetermined image size for each of the plurality of types of reading terminal devices. Thus, the digital book storage portion stores and accumulates dedicated book data for use only at each terminal device including image data having an image size corresponding to a screen size of the terminal device and digital book data having character data compatible with the same page of each piece of the dedicated book data in condition where they are correlated with each other, for each digital book.

File acceptance means in the invention can accept incoming the original image file when this original image file is uploaded to the server based on a predetermined user operation on a predetermined disclosed page (for example, on a Web site). In such a manner, many users capable of placing access to the Web site can easily create digital contents.

### BRIEF DESCRIPTION OF THE DRAWINGS

FIG. 1A is a block diagram schematically showing a digital book provision system of the invention.

FIG. 1B is a block diagram schematically showing a digital book provision system according to one embodiment of the invention.

FIG. 2 is a block diagram showing a configuration example of a server.

FIG. 3A is a diagram showing information stored in a storage device of the server.

FIG. 3B is a diagram schematically showing a configuration of digital book data.

FIG. 3C is a view schematically showing a configuration of page display-purpose data of a digital book.

FIG. 4 is a block diagram showing a configuration example of a first terminal device.

FIG. 5 is a diagram showing information stored in a storage device of the first terminal device.

FIG. 6 is a block diagram showing a configuration example of a second terminal device.

FIG. 7 is a diagram showing information stored in a storage device of the second terminal device.

FIG. 8 is a first screen display example of the digital book.

FIG. 9 is a second screen display example of the digital book.

FIG. 10 is a display example of a main page on a disclosed page on which the digital book can be created and read in a digital book provision system 1I.

FIG. 11 is a display example of a log-in page on the disclosed page on which the digital book can be created and read in the digital book provision system 1I.

FIG. 12 is a display example of a subscribing page on the disclosed page on which the digital book can be created and read in the digital book provision system 1I.

FIG. 13 is a display example of a digital book creation page on the disclosed page on which the digital book can be created and read in the digital book provision system 1I.

FIG. 14 is a display example of a digital book management page on the disclosed page on which the digital book can be created and read in the digital book provision system 1I.

FIG. 15 is a display example of a digital book search page (book narrowing-down page) on the disclosed page on which the digital book can be created and read in the digital book provision system 1I.

FIG. 16 is a view schematically showing one example of a page flipping moving picture (dynamic expression of page flipping) in the digital book.

FIG. 17 is an explanatory view of processing to exclude a protruding region.

FIG. 18 is a flowchart showing a flow of digital book creation processing.

FIG. 19 is an explanatory chart of a flow of the digital book creation processing.

FIG. 20 is a flowchart showing a flow of processing to read and distribute the digital book.

FIG. 21 is a display example of the log-in page on the disclosed page on which the digital book can be created and read in a digital book provision system 1L.

FIG. 22 is a display example of a user management page on the disclosed page on which the digital book can be created and read in the digital book provision system 1L.

FIG. 23 is a display example of a page for newly registering or editing user information on the disclosed page on which the digital book can be created and read in the digital book provision system 1L.

FIG. 24 is a display example of a digital book list display page (book narrowing-down page) on the disclosed page on which the digital book can be created and read in the digital book provision system 1L.

FIG. 25 is a display example of a digital book creation page on the disclosed page on which the digital book can be created and read in the digital book provision system 1L.

FIG. 26 is a display example of a group management page on the disclosed page on which the digital book can be created and read in the digital book provision system 1L.

FIG. 27 is a display example of a page for newly creation of a group and edition of group information on the disclosed page on which the digital book can be created and read in the digital book provision system 1L.

FIG. 28 is an explanatory view of a relationship between a registered user, a group, and a group-use book group.

FIG. 29 is a view showing a display example of a book information disclosure page.

FIG. 30 is a table showing one example of book information that constitutes part of digital book data.

FIG. 31 is a block diagram showing a configuration example of a page disclosure-purpose terminal device that displays a book information disclosure page.

FIG. 32 is an explanatory view of a relationship among a plurality of small groups, a large group to which those small groups belong, and a group-use book group of each of those groups.

FIG. 33 is a flowchart showing a flow of open information updating processing which updates open information to be displayed on a book information disclosure page.

FIG. 34 is a block diagram showing a configuration in a case where the digital book provision system of the invention is introduced to a field of education such as a school or a cram school.

### MODE FOR CARRYING OUT THE INVENTION

The following will describe an embodiment of a digital book provision system of the invention with reference to the drawings.

A name having (note 1) in the following is either a trademark or an article name.

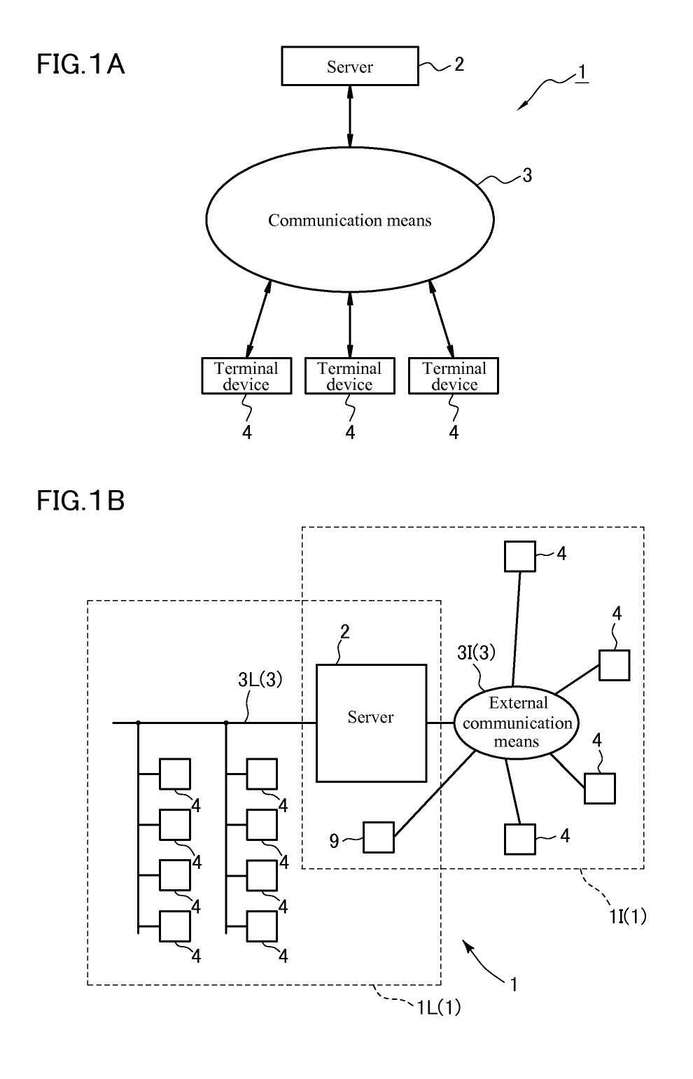

FIG. 1A is a block diagram schematically showing the digital book provision system according to one embodiment of the invention. A digital book provision system 1 shown in FIG. 1A includes a server (management device) 2, communication means (communication network) 3 to which the server 2 is connected, and an at least one terminal device 4 which can be connected to the communication means 3. Each of the terminal devices 4 accesses the server 2 via the communication means 3 to download necessary data (distribution book data) 250′ of data 250 of digital books accumulated in the server 2 and displays a digital book (a book-type digital content) based on the data 250′ on its own display portion 47. When reading the digital book which is displayed, sound may be produced from a speech output portion 46 as necessary. Further, a predetermined one of the terminal devices 4 can access the server 2 to create digital books.

The communication means (communication network) 3 can be made up of the internet or an intranet, a personal computer communication network, a public telephone line network, a local area network (LAN), etc.

In the following, first a description will be given of a system 1I shown in FIG. 1B, in which the terminal devices 4 connect to the server 2 via external communication means 3I (communication means 3) such as the internet.

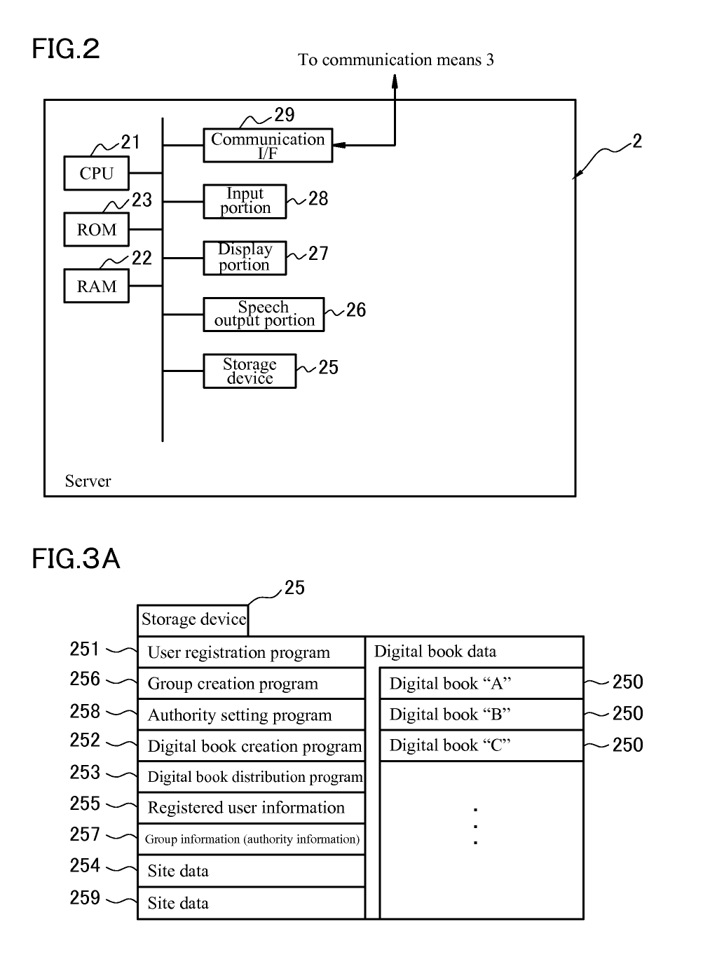

The server 2 is a computer which has a predetermined platform and operates on the base of the compatible operating system (not shown), to create a digital book in response to a demand from the terminal device 4 and distribute the created digital book such that it can be read at the terminal device 4. As shown in FIG. 2, in this configuration, the server 2 includes a storage device 25 including an ROM 23, an RAM 22, and a hard disk drive (HDD) which are connected to a CPU 21 and a known communication interface 29 for network connection, as well as an input portion 28 including a keyboard, a mouse, and other pointing device etc., a display portion 27 such as a liquid crystal display, and a speech output portion 26 such as a speaker, which are all connected.

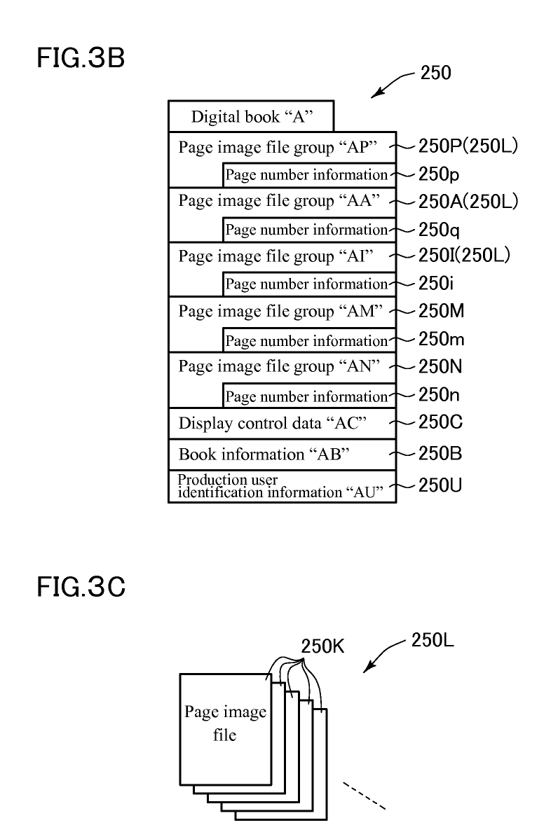

The storage device 25 stores various programs executed by the CPU 21 in the server 2 and various kinds of data necessary for execution of those programs. Specifically, as shown in FIG. 3A, the storage device 25 stores a user registration program 251, user information (registered user information) 255 related to registered users, a group creation program 256, group information 257 related to the created groups, an authority setting program 258, a digital book creation program 252, a digital book distribution program 253, digital books' data 250, and site data 254.

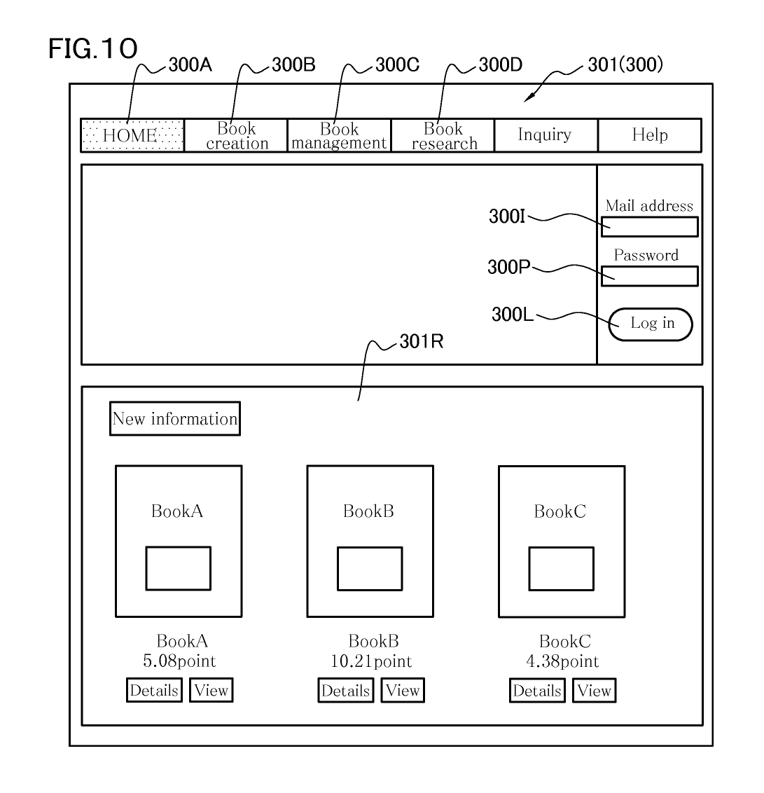

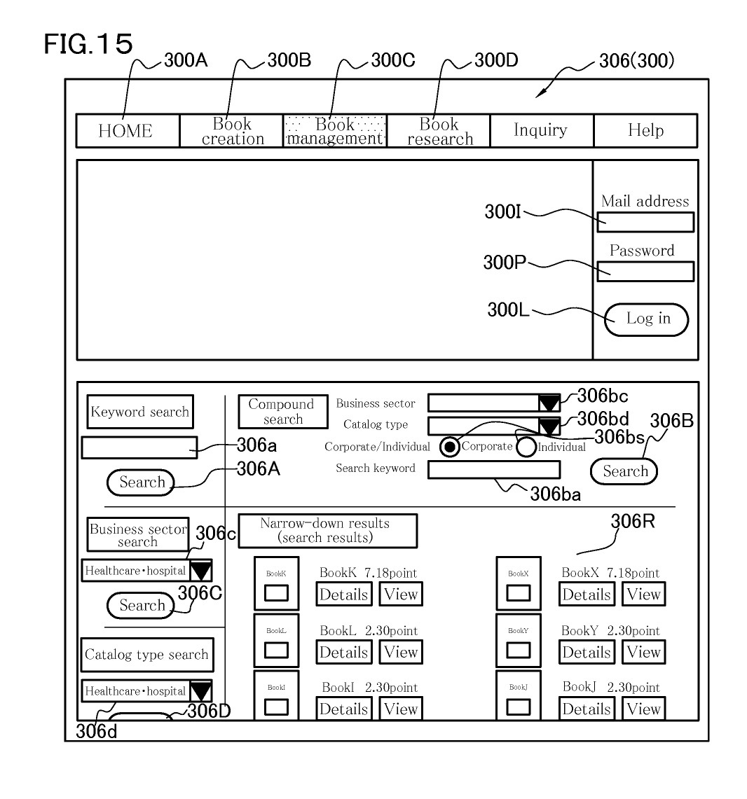

The site data 254 is used to disclose via the communication means 3 a user-use site 300 (disclosure page: refer to FIGS. 10 to 15), which provides a window for registration of users and creation and reading of digital books. If the terminal device 4 accesses the server 2 via the site 300, the server 2 can execute the programs 251, 252, and 253 described above and register users, create digital books, read created digital books, and narrow down digital books to be read, by way of the communication means 3.

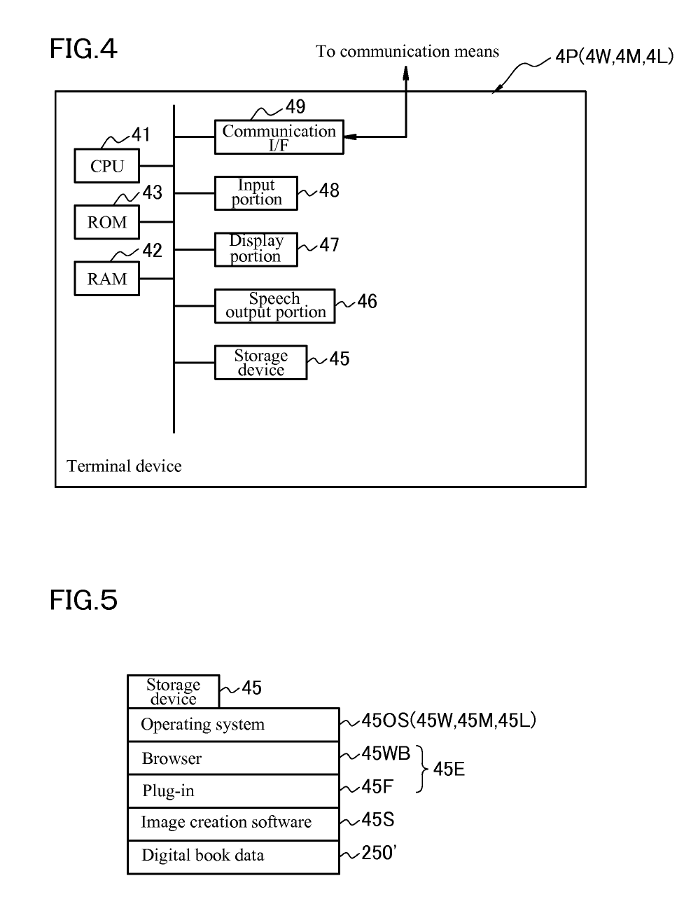

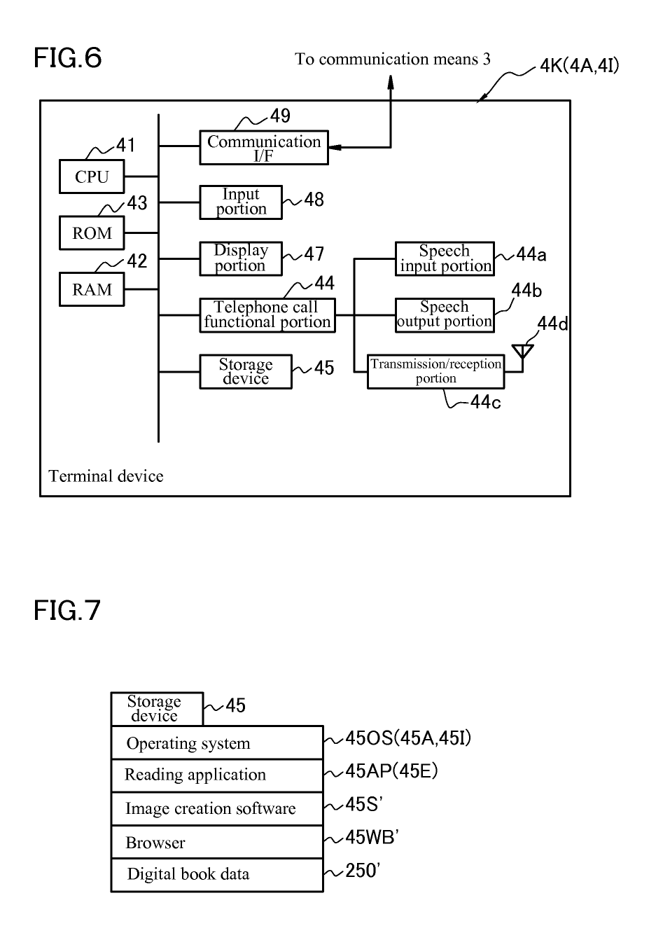

The terminal devices 4 may come in a plurality of types such as known personal computers 4P (4W, 4L, 4M: refer to FIG. 4) and portable type terminal devices 4K (4A, 4I: refer to FIG. 6). If they access the server 2, the programs 251, 252, and 253 in the server 2 can be executed to register users, create digital books, read created digital books, and narrow down digital books to be read. The terminal device 4, especially the portable type terminal device 4K can be configured to be able only to read digital books.

As shown in FIG. 4, the terminal device 4P includes a storage device 45 including an ROM 43, an RAM 42, and a hard disk drive (HDD) which are connected to a CPU 41 and a known communication interface 49 for network connection, as well as an input portion 48 including a keyboard, a mouse, and other pointing device etc., a display portion 47 such as a liquid crystal display, and a speech output portion 46 such as a speaker, which are all connected.

The plurality of types of terminal devices 4P are connected to the server 2 via the communication means 3 and can be computers having different platforms, for example, a terminal device 4W operating based on Windows (note 1) 45W, which is the operating system 45OS, a terminal device 4M operating based on Mac OS (note 1) 45M, and a terminal device 4L operating based on Linux (note 1) 45L. In the storage devices 45 of those respective terminal devices 4W, 4L, and 4M, various types of application programs depending on the respective operating systems 45OS are stored, including browser 45WB for reading the site 300 and a viewer (in this case, plug-in software such as Flash Player (note 1)) 45F for displaying the digital books on the browser 45WB. Furthermore, in creation of digital books, predetermined image creation software (in this case, Word (note 1), Excel (note 1), and PowerPoint (note 1) of Microsoft Office (note 1)) 45S is also included for creating their original image files.

As shown in FIG. 6, the portable type terminal device 4K has a configuration in which the nonvolatile storage device 45 including the ROM 43, the RAM 42, and a flash memory are connected to the CPU 41 and also the communication interface 49 for network communication and a telephone call functional portion 44 are connected.

In the speech telephone call mode, at the portable type terminal device 4K, a speech signal whose sounds are collected by a speech input portion (microphone) 44a is converted and compressed by the telephone call functional portion 44 into a digital speech signal and undergoes spread spectrum processing and D/A conversion processing and frequency conversion at a transmission-and-reception portion 44c to be transmitted wirelessly from an antenna 44d. Further, in the speech telephone call mode, the signal received at the antenna 44d is amplified by the transmission-and-reception portion 44c to then undergo A/D conversion and frequency conversion and, at the telephone call functional portion 44, inverse spread spectrum processing and is decompressed and converted into an analog speech signal to be output to the outside via the speech output portion (speaker) 44b.

The plurality of types of portable type terminal devices 4K are connected to the server 2 via the communication means 3 and can be computers having the different platforms, for example, those having various operating systems for dedicated use in portable telephones as the operating system 45OS. In this case, the portable type terminal device 4A is a portable telephone operating based on Android (note 1) 45A, which is the smart phone-use operating system, and the portable type terminal device 4I is a portable telephone operating based on the iOS (note 1) 45I, namely an iPhone (note 1). The portable type terminal device 4K may have a different platform from the above-described platform and operate based on various known portable telephone-use operating systems compatible with it.

The portable type telephone device 4K can be a so-called tablet computer such as an iPad (note 1), which is a portable computer having a flat sheet-shaped display/input portion such as a touch panel, including a small-sized POS terminal device. In this case, the portion related to the telephone call functions can be omitted to provide a configuration similar to that of the terminal device 4P. As the operating system 45OS, the OS compatible with this terminal device is appropriately employed (for example, the 45I in the case of an iPad (note 1)).

In the storage devices 45 of those respective portable type terminal devices 4K (4A, 4I), various types of application programs depending on the respective operating systems 45OS are stored, including terminal-dedicated reading-purpose application (viewer) 45AP for reading the digital books. In a case where the portable type terminal device 4K is a high-spec device such as a smart phone, the programs include predetermined image creation software (in this case, Word (note 1), Excel (note 1), and PowerPoint (note 1) of Microsoft Office (note 1)) 45S for creating an image file to be prepared as original image data of each of pages of a digital book and also browser software 45WB′ for reading the site 300.

In the storage devices 45 of the respective terminal devices 4P (4W, 4L, 4M) and 4K (4A, 4I), digital book data 250′ distributed (transmitted) from the server 2 for reading the digital books is stored. If the CPU 41 of the terminal devices 4P and 4K execute browser 45WB or application 45AP to access server 2 via a screen appearing on the display portion 47, each of the terminal devices can download the data 250′ necessary for reading on its own of the digital book data 250 stored in this server 2, which data 250′ is stored in the storage device 45. Further, it is possible to display a digital book on the display portion 47 based on the downloaded data 250′ and read it by executing browser 45WB and plug-in 4F and the reading-purpose program 45E such as reading-purpose application 45AP. That is, the terminal device 4 can be made to function as a digital book reading device.

Now, a description will be given of a digital book of the embodiment.

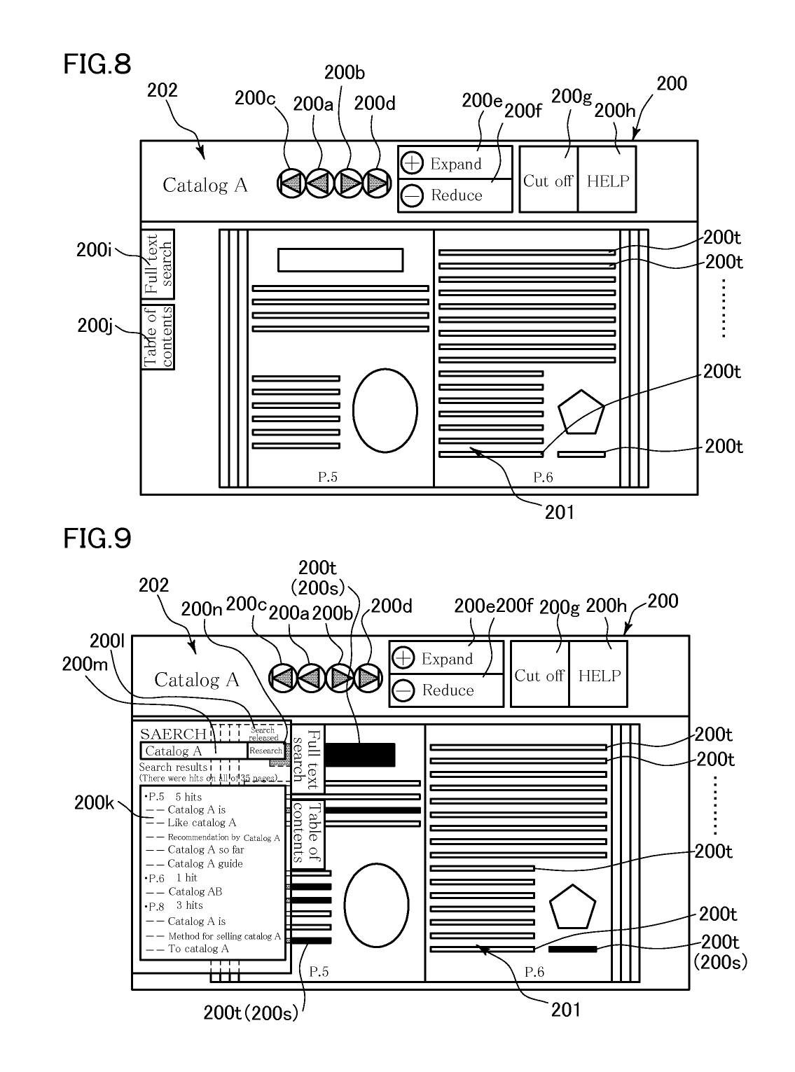

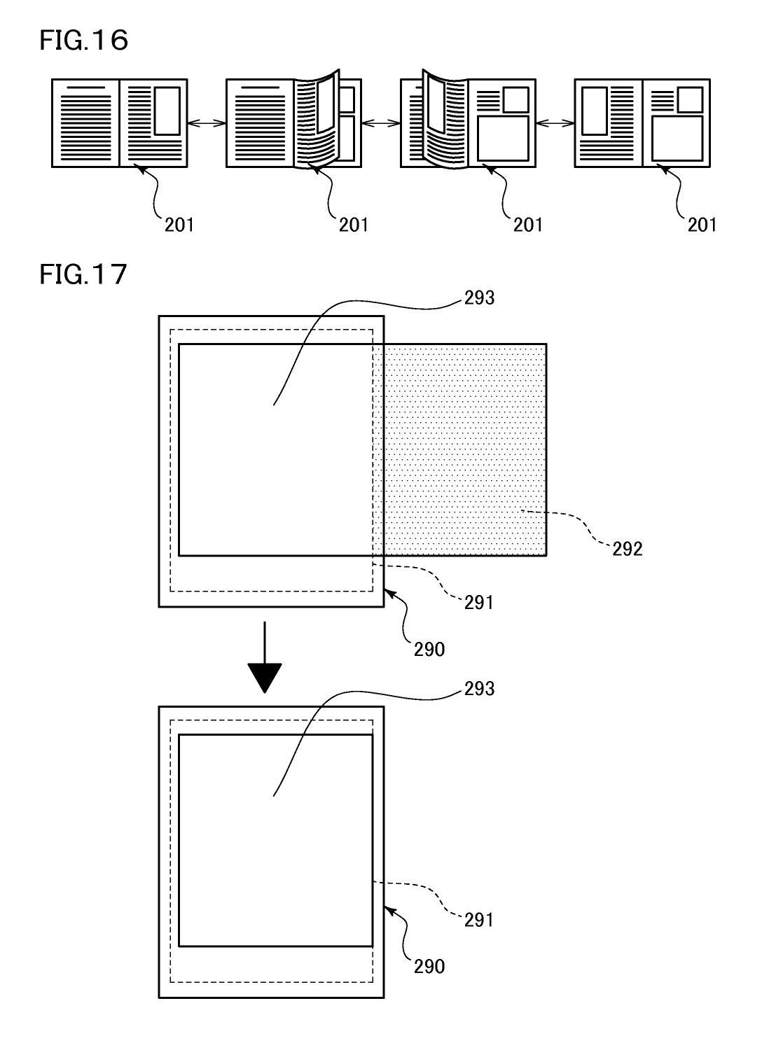

A digital book is a book-type digital content that can be read in page units. In the embodiment, as shown in FIGS. 8 and 9, the digital book can be displayed on the display portion 47 of the terminal device 4 and read in page units (more specifically, in double-page units in this case) in the form of displaying page flipping in a page flipping moving picture (see FIG. 16), namely a page flipping format. Such digital books can include catalogs and brochures and book-type digital contents such as a book, a newspaper, and information. As shown in FIGS. 8 and 9, the digital book of the embodiment may be a digital catalog obtained by transforming a catalog into an electronic book and can be read by the plurality of types of reading terminal devices 4.

A moving picture of page flipping in the embodiment is expressed as an animation which shows how pages are flipped by defining a coordinate system compatible with the shape of a page in each process of page flipping and sequentially switching the coordinate systems, while at the same time applying image data of the flipped page to each of the coordinate systems (see JP-A No. 2010-278905).

Further, the reading-purpose program 45E of each terminal device 4 is peculiar to the type of the terminal device 4, and thus has different display modes with the different types of the terminal device 4. For example, the reading-purpose program 45E of each terminal device 4 is arranged such that at the terminal device 4 having a comparatively large screen size (for example, terminal device 4P), a digital book may be displayed in a double-page format, while at the terminal device 4K (4A, 4I) having a comparatively small screen size, a digital book may be displayed in a single-page format. FIGS. 8 and 9 are each one example of display of the digital book at the terminal device 4P (4W).

The types (terminal types) of the terminal devices 4, referred to here, are predetermined for the respective reading terminal devices 4 and classified by differences in standards of images to be displayed on the screen. The standards are classified to various types by differences in terminal shape and operating system, manufacturer, and product part number for each of the manufacturers. For example, the image size (either field angle or resolution) of images to be displayed on the screen and the image file format change from terminal to terminal.

The respective data (digital book data) 250 of digital books “A”, “B”, “C”, . . . stored in the server 2 has one group (page image file group) 250L of page-specific image files (page image files) 250K used to display each page such as shown in FIG. 3C as the page display-purpose data (page image data) 250L used to display each page of those respective digital books for each type of the terminal devices 4, as shown in FIG. 3B.

Although the data 250 of the digital book “A” is illustrated in FIG. 3B as one that has the respective page display-purpose data (page image file groups) 250P, 250A, and 250I of the three types of terminal devices 4P, 4A, and 4I, actually the data 250 has the page display-purpose data (page image file group) 250L for each model of the more types classified by differences in terminal shape and operating system, manufacturer, and product part number for each of the manufacturers.

Further, the respective digital books “A”, “B”, “C”, . . . of the embodiment have the image file groups 250P, 250A, and 250I having image sizes (either field angle or resolution or both of them) compatible with the terminal devices 4P, 4A, and 4I as the type-specific page display-purpose data 250L of the terminal devices 4P, 4A, and 4I. The terminal devices 4P, 4A, and 4I for use in reading digital books have the different type-specific screen sizes and the different image sizes optimal in display; therefore, in the embodiment, the terminal devices 4 have each page's image file 250K having an image size optimal for each of them as page display-purpose data 250L (250P, 250A, 250I) compatible with the terminal devices 4, respectively. When a digital book is downloaded to be read, as the page display-purpose data 250L, only the page display-purpose data 250L having an image size compatible with the terminal device 4 to read it is downloaded and displayed.

That is, as the page display-purpose data 250L of one digital book, the storage device 25 in the server 2 of the embodiment prepares (stores) beforehand the image file groups 250P, 250A, and 250I containing the image file 250K of all the pages of this digital book for the respective terminal devices 4 predetermined as a to-be-read device. Digital book data “A” shown in FIG. 3B has an image file “AP” of all the pages compatible with the terminal device 4P, an image file “AA” of all the pages compatible with the terminal device 4A, and an image file “AI” of all the pages compatible with the terminal device 4I. Those image file groups “AP”, “AA”, and “AI” have the same images (contents to be drawn) to be displayed on the basis of the image file 250K on the same page but are different only in image size of them. This is true also with the digital book data 250 of the other digital books in FIG. 3B (for example, digital books “B” and “C” . . . ). The file format may be different with the different types of the terminal devices 4.

Further, each of the digital book data 250 stored in the server 2 has the page display-purpose data 250L which is used to display each page of the digital book as well as page number information 250p, 250a, and 250i which are used to identify correlations between these page display-purpose data 250L and page numbers of the pages. In this case, the page number information 250p, 250a, and 250i are given as file names of the page image files 250K of the page display-purpose data 250L.

Moreover, the data 250 of each digital book stored in the server 2 has display control data (flash data in this case) 250C which is described in a predetermined program language and functions as a program to display the digital book in page units based on the page image file groups 250P, 250A, and 250I and the page number information 250p, 250a, and 250i. That is, if read by the reading-purpose program 45E peculiar to each terminal device 4, the display control data (reading control program) 250C of the embodiment is displayed in a predetermined book content display frame 200 such that it can be read as book-type digital contents (digital catalogs in this case) to display images of each page of the digital book in page units (double-page units in the case of an ordinary personal computer), as shown in FIGS. 8 and 9.

Specifically, the display control data (flash data) 250C is a program which is executed (reproduced) by the viewer (plug-in software such as Flash Player (note 1)) 45F that operates in the browser 45WB when this browser 45WB is executed by the CPU 41 in the terminal device 4P. This program reads various kinds of setting files including each image file 250K constituting the page display-purpose data 250P (250L) compatible with the type of this terminal device 4P, provides a page display portion 201 in the book content display frame 200 on the screen of the display portion 47, displays in the page display portion 201 a page to be read based on this page's image file 250K, and, if page movement operations are performed, displays it such that a destination page may be opened while simultaneously reproducing a page flipping moving picture which dynamically draws page flipping.

At the same time, the display control data (flash data) 250C is also a program that is executed (reproduced) when the reading-purpose application 45AP is executed by the CPU 41 in the portable type terminal device 4K. This program reads various kinds of setting files including each image file 250K constituting the page display-purpose data 250A (250L) or 250I (250L) compatible with the type of the terminal device 4K, provides the page display portion 201 in the book content display frame 200 on the screen of the display portion 47, displays in the page display portion 201 a page to be read based on this page's image file 250A or 250I, and, if page movement operations are performed, displays it such that a destination page may be opened while simultaneously reproducing a page flipping moving picture which dynamically draws page flipping.

Although the display control data 250C is flash data in this case, the invention is not necessarily limited to it.

In the embodiment, as shown in FIGS. 8 and 9, the book content display frame 200 has the page display portion 201 which displays a page to be read in a digital book and a operation button display portion (operation image display portion provided at the left end portion or the top portion in FIGS. 8 and 9) 202 which displays operation buttons (operation images) 200a to 200j for operating predetermined commands on the digital book displayed in the page display portion 201.

The page display portion 201 displays to-be-read one page or double pages of a digital book contained in the downloaded page display-purpose data 250L, based on the image file 250K of the to-be-read pages.

The operation button display portion 202 displays the operation buttons corresponding to various commands. If the user performs a predetermined button selection operation to the input portion 48 to select or determine one of the various operation buttons, an operation command corresponding to the selected or determined operation button is executed.

There are the operation buttons 200a to 200j in FIGS. 8 and 9. As the operation commands, those operation buttons are respectively assigned a page return function (200a), a page feed function (200b), a page movement-to-top-page function (200c), a page movement-to-last-page function (200d), an enlarged-display function (200e), a reduced-display function (200f), a function to copy a predetermined region in a page display region 200A (200g), a help display function (200h), a character string search function to perform character string search for a sentence (character string) 200t drawn in each page (200i), and a table-of-contents display function to display a table of contents of the relevant digital book (200j). Additional functional operation buttons may be provided as the operation buttons.

The predetermined button selection operation by the user to the input portion 48 may involve performing a predetermined selection/determination operation in condition where the operation button's position is indicated by a pointer arbitrarily movable and operable on the screen in the case of the terminal device 4 (for example, personal computer 4P) that has a pointing device as the input portion 48, a predetermined selection/determination operation in condition where a operation button's position is indicated by a cursor which shifts to the neighboring operation button through key operations on the device (for example, potable type telephone) if it has an up/down key or a cross key as its input portion 48, or selection/determination by means of touch input on the screen.

Further, the digital book data 250 has the page display-purpose data 250L (page image file groups 250P, 250A, and 250I for each of the type of the terminal device 4) to display each page of a digital book (digital catalog in this case) as well as character data (search-use text data) 250M, which is text data of character strings drawn on each of the pages, and display position data 250N which indicates display positions (coordinates on a coordinate system set on the page in this case) of the character strings drawn on each of the pages, enabling searching (keyword searching) for the character strings based on this character data 250M, identifying the positions of the searched-for character strings (keywords) on the page, and spotlighting the periphery of the identified positions on the terminal device 4. The storage device 25 of the server 2 of the embodiment prepares (stores) beforehand the data 250 of one digital book in the shape of the character data (text file) 250M compatible with each page of the digital book and the display position data (text file) 250N compatible with each of the pages. Moreover, the character data 250M and the display position data 250N are segmented for each page and respectively have page number information 250m and 250n that enable identifying correlations between each of the data and each of the page numbers. Accordingly, correlations are provided with the page display-purpose data 250P, 250A, and 250I having page number information 250p, 250a, and 250i similarly.

The display control data 250C of the embodiment is a program which is executed (reproduced) by the reading-purpose programs 45E (45WB and 45F, 45F, or 45AP) executed by the CPU 41 of the terminal device 4, displaying on the screen of the display portion 47 a digital book that enables reading various setting files including the files of the page display-purpose data 250P, 250A, and 250I, the search-use text data 250M, and the display position data 250N to enable searching for character strings based on the search-purpose text data 250M, and spotlighting the searched-for character strings based on the display position data 250N. Specifically, if executed by the reading-purpose program 45E (45WB, 45F), the display control data 250C of the embodiment is assumed to be a program that can search for a character string (keyword search) in a digital book through predetermined selection/determination operations on the character-search operation button 200j shown in FIG. 8 and also spotlight a display position of the searched-for character string (keyword) if this position is displayed in the book based on the display position data 250N.

In the embodiment, as shown in FIG. 3B, the digital book data “A” has a search-purpose text file “AM” as the character string search-purpose character data 250M. Accordingly, if operations are performed to select/determine the operation button 200i in FIG. 8, a character string is searched for as shown in FIG. 9. That is, if the operation button 200j is selected and determined in FIG. 8, a searched-for character string input portion 200m to input a searched-for character string, a searching operation button 200n, and a search result display portion 200k to display search results are shown over the page display region 202 as shown in FIG. 9. Moreover, in this case, a search releasing operation button 2001 is also displayed which is assigned a function to release search states (searching state and search result display state) in order to return to the state shown in FIG. 8. If a character string to be searched for is input to the search character string input portion 200m and the searching operation button 200n is operated, the search result display portion 200k displays search results in a list as shown in FIG. 9.

Further, the search results are displayed also on the page display portion 201 visually. Specifically, a marking image 200s including at least the searched-for character string is displayed and spotlighted in a peripheral region of this searched-for character string defined by a predetermined method such that it may be more remarkable than the other regions. The peripheral region of the searched-for character string in the embodiment is defined as a “line” including this searched-for character string. The state in which the marking image 200s is displayed continues unless the search state is released. For example, even in a case where the page is moved from the state in FIG. 8 to that in FIG. 9, if a searched-for character string that should indicate the marking image 200s is displayed on the movement destination page, the marking image 200s is displayed on this page. In the embodiment, if any of the selection/determination operation on the search releasing operation button (search releasing operation image) 2001, an operation to end reading of book type digital contents, and an operation to search for another character string is performed, display of the marking image, which is the results of the immediately preceding search, ends. If another character string is searched for, display of the marking image 200s hitherto indicated ends; however, if the character string gets a hit in new search, a marking image 200s corresponding to this character string is newly displayed.

The character data 250M referred to here means text data includes data such as symbols used on a regular basis of the society to express a language (ideographic characters, phonograms, logograms (lexigrams), syllabic characters, and monophonic characters) and symbols and characters used to express numbers (Arabic numbers (“1”, “2”, etc.), Roman numbers (“,”) etc.), and Chinese numbers (“ [symbol] ”, “ [symbol] ”, etc.). The character data 250M need not be prepared for each type of the terminal device 4 in contrast to the page display-purpose data 250P, 250A, and 250I but only needs to have correlations between the data of each page of the page display-purpose data (page image file groups) 250P, 250A, and 250I and the data (data of each image file 250K) of each page of the character data 250M and the display position data 250N. In this case, the correlations are provided using the page number information 250p, 250a, 250i, 250m, and 250n.

Thus, if the reading-purpose program 45E peculiar to each of the terminal devices 4 (4P, 4K) is executed, the display control data 250C of digital book data of a digital book of the embodiment is read, so that based on the read display control data 250C, it is possible to display the digital book and perform various predetermined command operations on this digital book.

Now a description will be given of processing (digital book creation means) to create the digital book (digital book data 250) described above.

The digital book can be created only by the user registered on the site 300, which provides the window for creation/reading of digital books, who places access to the site 300 from the terminal device 4 and logs in to it. On the site 300, predetermined user registration processing can be performed on condition that predetermined user information (personal or corporate information) must be input.

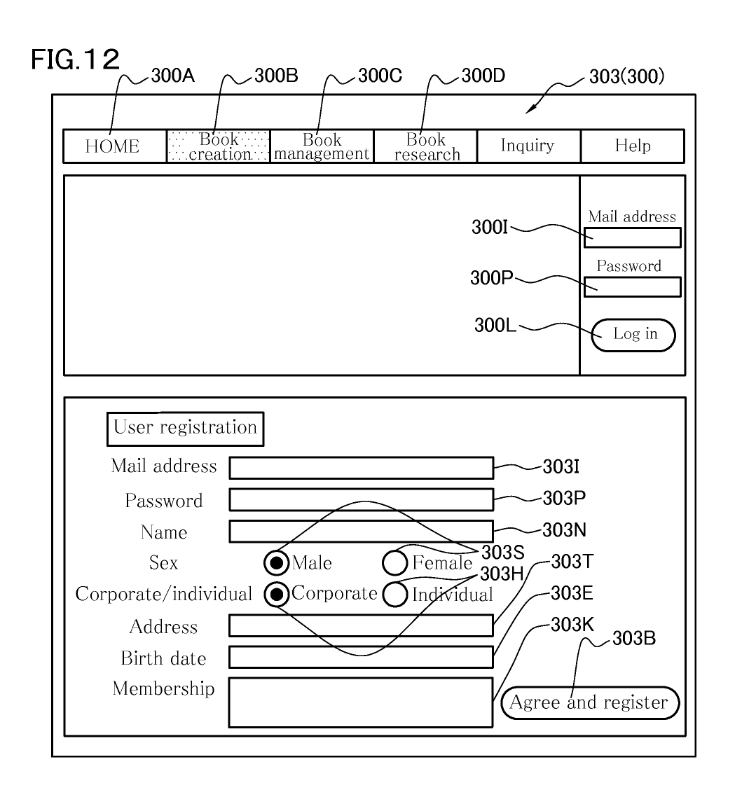

In the user registration processing in the embodiment, as shown in FIG. 12, on a predetermined member registration page 303 at the site 300, the user would input his/her user information such as “mail address”, “log-in password”, “name”, “sex”, “corporate/personal”, “address”, and “birth date” by performing predetermined user operations (user information input operations) to the input portion 48. Then, the user would perform predetermined user operations (in this case, user information registration operations to select a registration button 303B on the input portion 48) to the input portion 48 in agreement with predetermined terms, so that those inputs are accepted to complete user registration. The input user information is stored by the CPU 21 in the server 2 into the storage device (registered user storage portion) 25 as registered user information 255.

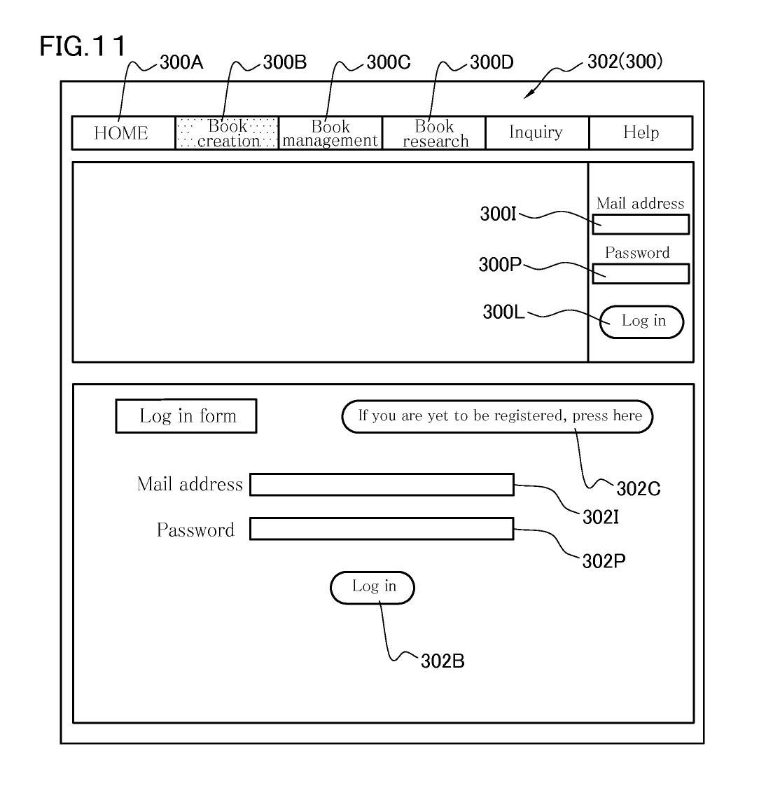

Further, in the embodiment, to log in to the site 300, it is necessary to input log-in information such as “mail address” and “log-in password” into predetermined input columns 300I, 300P, 302I, and 302P on a log-in page 302 at the site 300 (see FIG. 11) or on pages 301 to 306 by performing predetermined user operations (log-in information input operations) to the input portion 48. Then, by performing predetermined user operations (in this case, operations to select a log-in button 302B or 300L on the input portion 48: log-in determination operations), the log-in processing is completed. The log-in page 302 is displayed by selecting and operating a book creation button 300B provided on each page on the site 300 by using the input portion 48. If the user registration processing is yet to be performed in a phase when the log-in page 302 is displayed, an operation button 302C on the log-in page 302 can be selected and operated by the input portion 48 to shift to the member registration page 303 in FIG. 12 in order to perform the user registration processing.

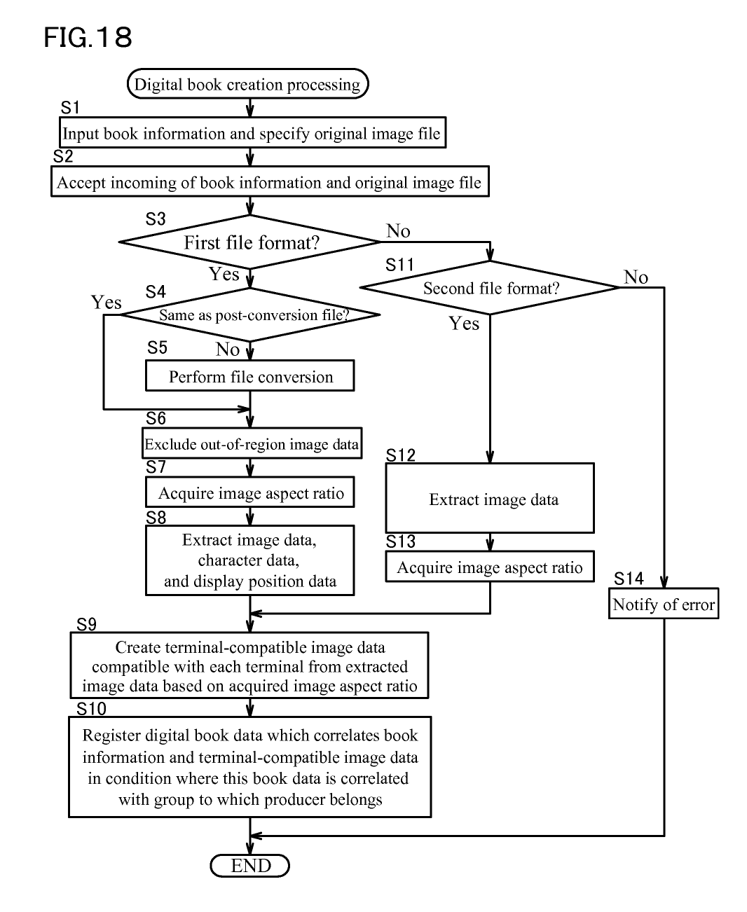

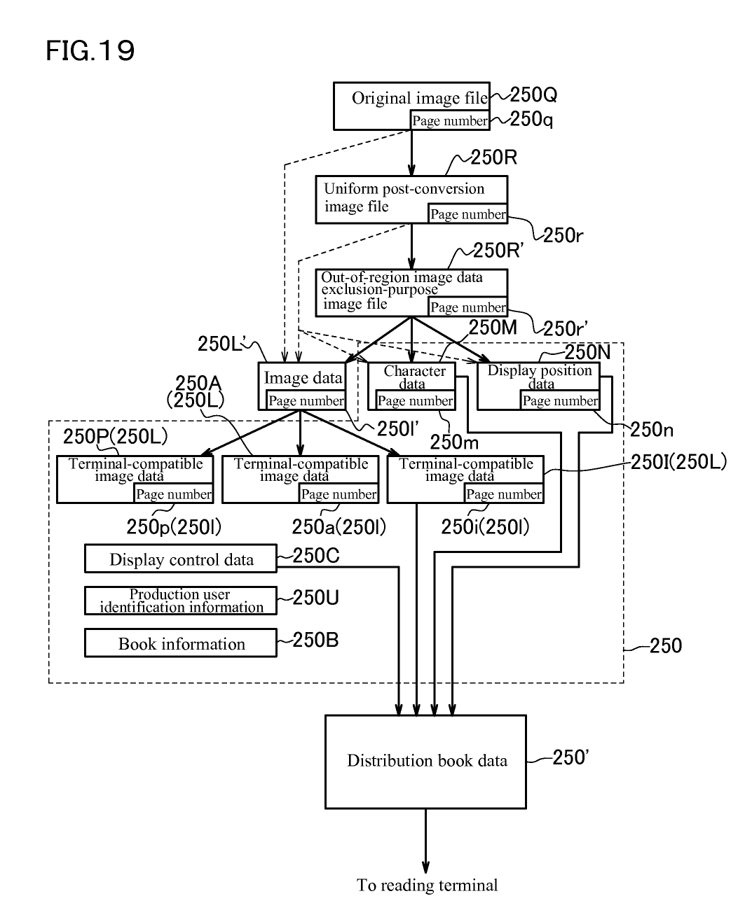

The following will describe a specific processing flow to create a digital book with reference to FIGS. 18 and 19 on the assumption that a log-in state is already provided by a registered user.

In this case, creation of the digital book data “A” in FIG. 3 will be described as an example. A digital book displayed by the digital book data “A” is a digital catalog.

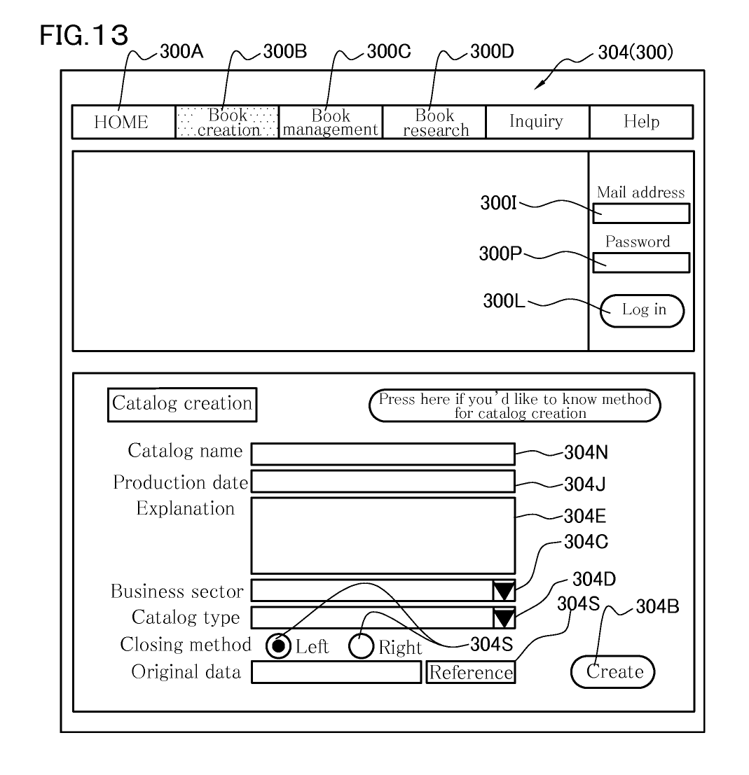

First, if the user completely logs in to the site 300 on the log-in page 302, the shift is made to a catalog creation page 304 shown in FIG. 13.

In S1, on the catalog creation page 304, predetermined user operations (book information input operations) on the input portion (keyboard or numeric keypad) 48 are performed to input necessary information (book information) 250B related to a catalog to be created. In this case, the following information will be input as the necessary information (book information) 250B. The necessary information is not limited to the following; other information (for example, an introductory sentence for the book) may be given or some of the following items may be omitted.

Catalog name (book name)”

Catalog title (symbol 304N is a region to input it)

“Production date (book production date)”

Date on which it is produced (symbol 304J is a region to input it)

“Explanation (book explanation sentence)”

Explanation of catalog contents (symbol 304E is a region to input it)

“Business sector (producer user type information)” (symbol 304C is a region to input it)

For example, the business sector candidates are as follows (symbol 304C is a display region for selection: pull-down menu display region): apparel, fiber/healthcare, hospital/catering•restaurant/food•supermarket/commodities•general groceries•home appliance/department store•retailer/printing, publishing/school, education, language/public office, administrative institution/financial institution•bank/manufacture, construction/vehicle•car•bike/real estates•real estate business/internet•IT-related/service business/beautification health/sports•facilities/travel•sightseeing/hotel•accommodation facility/leisure•outdoor/culture•school•cram school/event business•facilities/others

“Catalog types (book type information, namely categories)”

For example, the business sector candidates are as follows (symbol 304D is a display region for selection: pull-down menu display region): corporate profile/manufacturer catalog/mail-order catalog/product guide/magazine•photo album/ecology-related/research material/flyer•advertisement/album/diary/literatures•reviewal/culture•idea/society•political nonfiction/history•geography/business•economy/investment•finance•corporate management/science•technology/medicine•pharmacy/computer•IT art•architecture•design/practical use•sports•hobby/qualification•certificate/living•health•nurturing/travel guide/language•dictionary•almanac/education•study guide•examination/children/comics•animation•BL/game playing guide book/entertainment/new type paperback•conventional paperback/magazine/musical note•score•music book/poster/others

“Closing method (book display mode information)”

“Left side closing” or “right side closing” (symbol 304S is a display region to select them: radio bottom region)

Further, in S1, on the catalog creation page 304 shown in FIG. 13, predetermined user operations (upload file specification operations: in this case, operations to operate a reference button 304C in order to specify an original file) to the input portion 48 are performed to specify an image file (hereinafter referred to as original image file) 250Q prepared as data which provides an image of each page (see FIG. 19). That is, the original image file 250Q is an image file having original image data (page display-purpose data to display each page) which constitutes the base of each page in a digital book, original character data (character data to indicate a character string to be drawn using this page display-purpose data) which provides character information to be drawn using this original image data, and original display position data which provides display position information of character information to be drawn by this original image data in condition where they are correlated with each other.

In the following step of S2, the CPU 21 accepts necessary information (book information) 250B related to the catalog input in S1 (book information acceptance means) and accepts incoming of the specified original image file 250Q (see FIG. 19) (file acceptance means). In this case, predetermined user operations (creation determination operations: in this case, determination input operations on the creation button 304B) on the input portion 48 are performed on the catalog creation page 304 shown in FIG. 13 to cause the CPU 21 having accepted the input of those operations to accept incoming the various necessary information “AB” (book information 250B) related to the catalog input in S1 and the one original image file 250Q specified in S1.

In the following step of S3, the CPU 21 decides whether the original file 250Q whose incoming is accepted in S2 is a predetermined first acceptable file (first file decision means). The first acceptable file refers to an image file having a predetermined plurality of file formats (first file formats) of image data, a plurality of types of image files having character data which provides character information to be drawn using this image data, and display position data which provides display position information of character information to be drawn using this original image data in condition where they are correlated with each other.

The first acceptable file in the embodiment is an image file that can be converted into the later-described uniform post-conversion image file 250R, where the uniform post-conversion image file itself is contained. In this case, a plurality of kinds of image files having a predetermined extension is defined as the first acceptable file; specifically, the image files having the following extensions are defined.

PDF file (extension: “.pdf”)

Word file (extension “.doc”, “.docx”)

Excel file (extension “.xls”, “.xlsx”)

PowerPoint file (extension “.ppt”, “.pptx”)

The first acceptable file in the embodiment can be read by predetermined software capable of creating images (in this case, Word (note 1), Excel (note 1), or PowerPoint (note 1) of Microsoft Office (note 1)) which is provided for each of predetermined operating systems such that it may operate in accordance with the same specifications on these different predetermined operating systems (for example, Widows (note 1), Mac, or Linux (note 1)) and contains image files having a file format in which files can be displayed and edited. The predetermined software may include, for example, predetermined presentation information creation software (in this case, PowerPoint (note 1)), predetermined sentence creation software (in this case, Word (note 1)), and predetermined table calculation software (in this case, Excel (note 1)).

If created by the predetermined software (Word (note 1), Excel (note 1), or PowerPoint (note 1) of Microsoft Office (note 1)), of course, an image file can be read by the software to display its pages on a predetermined page frame and create images and character strings for each of the pages and has original image data to display the images and character strings of each page in this page frame and original character data to indicate each page's character strings to be displayed on the basis of this original image data in condition where they are correlated with each other and also page settings in both of the data.

However, the first acceptable file need not be only an image file (Word/Excel/PowerPoint) that can be displayed and edited by the predetermined software (in this case, Word (note 1), Excel (note 1), or PowerPoint (note 1) of Microsoft Office (note 1)) but only needs to have any one of the extensions given above even if it is an image file (PDF) that can be read by software other than the software described above. Further, to create data of the original image file 250Q, the file may be created by software other than the software but only needs to have any one of the extensions given above in its file format in which it is saved after being created.

If it is decided that the one original image file 250Q whose incoming is accepted in S2 is the first acceptable file (YES in S3), the CPU 21 uniformly converts this one original image file 250Q into an image file 250R in a predetermined file format in which character data and display position data can be stored in condition where they are correlated with each other, creates one uniform post-conversion image file 250R having the original image data 250Q as uniform post-conversion image data, the original character data as uniform post-conversion character data, and the original display position data as uniform post-conversion display position data in condition where they are correlated with each other (first file conversion means in S5), and then goes to S6. However, if the original image file 250Q whose incoming is accepted in S2 has the same file format as the uniform post-conversion image file 250R (YES in S4), S5 is skipped to make the shift to S6.

The file conversion processing in S5 for conversion into the uniform post-conversion image file 250R is performed in the shape of uniformly converting the original image file 250Q into the uniform post-conversion image file 250R by utilizing a file conversion function provided beforehand to open source software (in this case, OpenOffice.org (note 1)) compatible with the predetermined software capable of image creation. Specifically, the original image file 250Q is virtually opened by a predetermined software having the file conversion function without displaying the screen, to permit the CPU 21 to execute a program which is programmed to automatically perform processing to convert it into the format of the uniform post-conversion image file and save it.

If the one original image file 250Q created by the software described above (Word (note 1), Excel (note 1), or PowerPoint (note 1) of Microsoft Office (note 1)) is read by the open source software (OpenOffice.org (note 1)) compatible with the software, of course, images and character strings of each page are similarly displayed in accordance with a display layout and page settings of each page at the time when the original image data of the original image file 250Q is read by the software (Word (note 1), Excel (note 1), or PowerPoint (note 1) of Microsoft Office (note 1)) and displayed. Moreover, if the one original image file 250Q is converted into one uniform post-conversion image file 250R by utilizing the file conversion function of this open source software (OpenOffice.org (note 1)), of course, uniform post-conversion image data in the uniform post-conversion image file 250R provides image data that displays images and character strings of each page in accordance with the inherited display layout and page settings of each page at the time when the original image data of the pre-conversion original image file 250Q is read by the software (Word (note 1), Excel (note 1), or PowerPoint (note 1) of Microsoft Office (note 1)) and displayed.

In the embodiment, the original image file 250Q decided to be the first acceptable file is uniformly converted into a PDF file, which is the uniform post-conversion image file 250R, by utilizing the PDF conversion function of the open source software OpenOffice.org (which supports reading and writing of file formats of the Microsoft Office family such as Word (note 1), Excel (note 1), and PowerPoint (note 1)). Thus, the image data of the original image file 250Q is converted into the PDF image data (uniform post-conversion image data), the character data of this original image file 250Q is converted into character string search-purpose PDF character data (uniform post-conversion character data: text data), and the display position data of this original image file 250Q is converted into display-purpose PDF display position data (uniform post-conversion display position data: text data) for use in search for character strings. Then, the PDF file 250R is generated in which the PDF character data and the PDF display position data are correlated with the PDF image data. Of course, the PDF file is generated as a file having the PDF image data that displays images and character strings of each page in accordance with the inherited display layout and page settings at the time when the original file 250Q is read by the software (Word (note 1), Excel (note 1), or PowerPoint (note 1) of Microsoft Office (note 1)) and displayed.

In the original image file 250Q in the embodiment, a page number is appended as page number information 250q to each page's image data contained in the file, for example, in the shape of page settings for printing. In S5, when the original image file is uniformly converted into the uniform post-conversion file (in this case, PDF file) 250R, a page number is appended as the page number information 250r also to each page's image data in the uniform post-conversion image file 250R based on the page number information 250q of the original image file 250Q.

That is, the image file belonging to the first acceptable file already has a plurality of kinds of constant image files (in this case, PDF/Word/Excel/PowerPoint files) to which page settings are already defined; each display region for those files is divided in page units such that the page numbers 250q may be sequentially added from the top page to the last page. Accordingly, in S5, this original image file 250Q is converted into the uniform post-conversion image file (PDF file) 250R without changing the page settings of the original image file 250Q. In such a manner, each page's image data in the original image file 250Q is converted into the uniform post-conversion image file (PDF file) 250R in a manner such that a relationship between each page's page number and drawn contents and a relationship between each page's page number and character data may both be unchanged. That is, between each page's image data in the original image file 250Q and each page's image data in the uniform post-conversion image file 250R, the image data having the same page number have the same contents to be drawn and also the same character data to be correlated.

There is a possibility that the page numbers of the original image file 250Q may disagree with the page numbers of the uniform post-conversion image file 250R in the process of conversion. The disagreement occurs if the page setting information defined in software utilized in uniform conversion of the original image file 250Q into the uniform post-conversion image file 250R is different from the page settings of the original image file. Accordingly, the state of the page settings of the original image file 250Q opened in this software is held as it is after it is converted into the uniform post-conversion image file 250R but may possibly be different from the information of the page settings of the original image file. To prevent such a difference, the page setting information of the software to be utilized in uniform conversion can be adjusted beforehand as necessary.

The possibility is not totally zero that the displayed contents of each page when the original image file 250Q (original image data) is read by the software described above (Word (note 1), Excel (note 1), or PowerPoint (note 1) of Microsoft Office (note 1)) may disagree with the contents displayed when the uniform post-conversion image file 250R (post-conversion image data) is read by viewer software of the file in the process of conversion. For example, there is a slight possibility of occurrence of shifting of positions and lacking of ends of the display region. However, the expression “in accordance with the inherited display layout and page settings of each page” in the invention is meant to tolerate such occurrences and accommodate those states. At least if the file 250Q in the software (Word (note 1), Excel (note 1), or PowerPoint (note 1) of Microsoft Office (note 1)) is read by the software (Word (note 1), Excel (note 1), or PowerPoint (note 1) of Microsoft Office (note 1)) and converted into the uniform post-conversion image file 250R, the display layout and the page settings are not greatly changed, so that a slight mismatch due to the conversion is to be tolerated.

In the following step of S6, as shown in FIG. 17, the CPU 21 excludes an image data portion 292 protruding to the outside from a predefined display range 291 in the uniform post-conversion image file 250R (290), to perform processing to leave only an image 293 in this display range 291 (protruding region image exclusion means). The processing is performed specifically when the CPU 21 performs a protruding region exclusion program which is programmed to identify an image data portion 293 that does not protrude to the outside from the predefined display range 291 in the PDF image file 250R (290) and delete the other image data portion 292. Thus, the portion 292 outside the predefined display range 291 in the PDF image file 250R (290) is automatically excluded, to leave the image 293. However, the processing in S6 is not always necessary; if it is assumed beforehand that nothing protrudes from the display range 291, S6 can be omitted to make the shift to S7 and S8 without changing the uniform post-conversion image file 250R.

In the following step of S7, the CPU 21 acquires (extracts) image aspect ratio information that indicates the aspect ratio of an image to be displayed by the image data of the image file 250R′ that has only the image 293 in the predefined display range 291 because the image data portion 292 protruding from this display range 291 to the outside is excluded.

In the following step of S8, the CPU 21 extracts each page's image data 250L′ from the image file 250R′ (image data extraction means) and extracts the character data 250M and the display position data 250N which are correlated with each page's image data 250P′ from this image file 250R′ (character data extraction means and display position extraction means).

That is, in S8, the image data 250L′ is extracted from the image file 250R′ in this predetermined format by utilizing a known image data extraction function which is provided beforehand to software (in this case ImageMagic (note 1)) capable of reading the image file 250R′ and displaying it and which extracts image data 250P′ from this image file 250R′. Specifically, when the CPU 21 executes the predetermined software (in this case, ImageMagic (note 1)) programmed to have a function to convert the image file 250R′ into an image having a predetermined file format (in this case, JPEG file) in which character data cannot be correlated with image data, processing is automatically performed to virtually open the image file 250R′ without involving screen display and convert this image file 250R′ into a predetermined file format (in this case, JPEG file). As a result, an image file is generated which has excluded the character data and the display position data from the image file 250R′. In other words, a state is provided in which only the image data 250L′ is extracted from the image file 250R′.

Although the image file 250R′ is one image file having images on all the pages that constitute a digital book, in the case of extracting only the image data 250L′, it is extracted (generated) as an image file (JPEG file) for each page.

Also, in S8, the character data 250M and the display position data 250N are extracted from the image file 250R′ by utilizing a known character data extraction function which is provided beforehand to software (in this case PDFtet (note 1)) capable of reading the image file 250R′ and displaying it and which extracts the character data 250M stored as correlated with its image data 250L′ and a known display position extraction function which extracts the display position data 250N stored as correlated with its image data 250L′. Specifically, when the CPU 21 executes the predetermined software (in this case, PDFtet (note 1)) programmed to have an extraction function to extract text data from the image file 250R′, processing is automatically performed to virtually open the image file 250R′ without involving screen display and extract the character data 250M and the display position data 250N, which are text data, from this image file 250R′ as independent text files respectively.

To the uniform post-conversion image file 250R and the image file 250R′, page numbers (page number information 250r, 250r′) are added; to the image data 250L′ and the text data (character data and display position data) 250M and 250N extracted from the image file 250R′ also, page numbers (page number information 250l′, 250m, 250n) are added based on the page number information 250r′ of this image file 250R′. Since the image data 250L′ is an image file (in this case, JPEG file) whose pages are generated one by one, to such an image file, the page number information 250l′ are sequentially added based on the page number information 250r′ of the image file 250R′. In this case, the page number information 250l′ is added as the file name of an image file on each of pages to be generated one by one.

Then, in S9, the CPU 21 generates the image data 250L used to display each page of the digital book “A” from the image data 250L′ extracted in S8 for each of the plurality of types of terminal devices 4P, 4A, and 4I (terminal-compatible image data generation means). In this case, the terminal-compatible data “AP” (250P), “AA” (250A), and “AI” (250I) compatible with the display standards and the screen standards of the plurality of types of terminal devices 4P, 4A and 4I respectively are generated from the image data 250L′ extracted in S8 (see FIG. 3) and respectively provide the image data 250L used to display the pages of the digital book “A”. Specifically, the plurality of types of terminal devices 4P, 4A, and 4I have different image sizes (field angle and resolution) peculiar to each type, so that the CPU 21 changes the image data 250L′ to image data having predetermined image sizes that fit the image size (field angle and resolution) of the respective display portions 47 of the predetermined plurality of types of terminal devices 4P, 4A, and 4I based on the image aspect ratio information extracted in S7 and provides the size-changed image data as terminal-compatible image data “AP”, “AA”, and “AI” for the terminal devices 4P, 4A, and 4I respectively. However, aspect ratios of the thus generated terminal-compatible image data “AP”, “AA”, and “AI” are determined on the basis of the image aspect ratio information acquired in S7.

More specifically, the image data 250L′ extracted in S8 is a page image file group including image files (JPEG files) of all the pages, in which files are generated one by one as image files (in this case, JPEG files) compatible with the respective pages of the digital book. In S9, the CPU 21 generates this page image file group 250L′ for each of the predetermined plurality of types of terminal devices 4P, 4A, and 4I. However, the each page's image file 250K of the page image file group 250L generated for each of the terminal devices 4P, 4A, and 4I is generated in a form that has predetermined image size and file format that fit the screen size of the display portion 47 of each of the compatible terminal devices 4P, 4A, and 4I. The page image file group 250L generated for each of the terminal devices 4P, 4A, and 4I provides the terminal-compatible image data “AP” (250P), “AA” (250A), and “AI” (250I) (see FIGS. 3 and 19).

Further, in S9, as each page's image files in the digital books are generated one by one by the CPU 21 from the image data 250L′ extracted in S8, those each page's image files thus being generated are sequentially assigned the page number information 250l based on the page number information 250l′ of this image data extracted in S8. In this case, as the file names of the each page's image files thus being generated, the page number information 250l is added.

In the following step of S10, the CPU 21 correlates the terminal-compatible image data “AP”, “AA”, and “AI” generated in S9 with character data “AM” and display position data “AN” which are extracted in S8 and also correlates the display control data “AC”, logged-in registered user's identification information (identification information of the registered user engaging in creation of the digital book) “AU”, and necessary information (book information) “AB” accepted in S2 with each other and stores and accumulates them as the digital book data 250 in the storage device (digital book storage portion) 25. In this case, the display control data “AC” is available as left-side closing data and right-side closing data respectively. In S10, one of them corresponding to the book “closing method” input in S1 is selected and stored as the digital book data 250 in the storage device (digital book storage device) 25. The book may be “closed” not only on the right side and left side but also on the upper side and lower side. Further, in this case, the “closing method” rules the method of moving pages of a digital book and, in the embodiment, only needs to be able to at least page movement in page units and need not always involve page flipping. In some cases, the pages may be moved by sliding in page units.

If it is decided that the original image file 250Q whose incoming is accepted in S2 is not the first image file (NO in S3), the CPU 21 decides whether this original image file 250Q is a predetermined second acceptable file (second file decision means) in S10. The second acceptable file refers to an image file in a predetermined format (second file format) of the plurality of types of file formats in which character data cannot be correlated with image data.

The second acceptable file in the embodiment is an image file having a predetermined extension. In the embodiment, for example, a plurality of image files of a digital book can be made random for each of its pages and compressed into a compressed file. In the embodiment, as the second acceptable file, an image file having the following extension is defined.

zip (extension “.zip”)

In all cases, the second acceptable file covers all of in-zip files, so that their JPEG files are assigned the page number information 250q that provide page numbers of a digital book. Specifically, the file names of the JPEG files respectively start with “000.jpg”, “001.jpg”, “002.jpg”, . . . , in sequential numbers 000 through 999, which provide the page number information 250l′.

If it is decided that the original image file 250Q whose incoming is accepted in S2 is the second acceptable file (YES in S11), the shift is made to S12. In S12, the CPU 21 extracts (decompresses) individual JPEG files (jpg images) from a zip file that constitutes the original image file 250Q and, in S13, acquires (takes out) image aspect ratio information that indicates an aspect ratio of the jpg images based on the image data of the extracted JPEG files.

The processing in S9 following S13 is the same as that in S9 described above.

Furthermore, in the following step of S10, similar to the S10 described above, the CPU 21 correlates the display control data “AC” described above, the logged-in registered user's identification information (identification information of the registered user engaging in creation of the digital book) “AU”, and the necessary information (book information) “AB” accepted in S2 with the terminal-compatible image data (page images) “AP”, “AA”, and “AI” generated in S9 and stores and accumulates them as the digital book data 250 in the storage device (digital book storage portion) 25. However, in S109 in this case, the digital book data 250 contains no character data and, therefore, is not capable of keyword search.

If it is decided that the original image file whose incoming is accepted in S2 is neither the first image file nor the second image file (NO in S11), error display is provided on the catalog creation page 304 in FIG. 13 because the input original image data is not an image file having the predetermined extension (S14).

If the processing in S10 or S14 ends, the processing ends.

Now, a description will be given of processing, which is the second feature of the invention, to cause the digital book (digital book data) to be read.

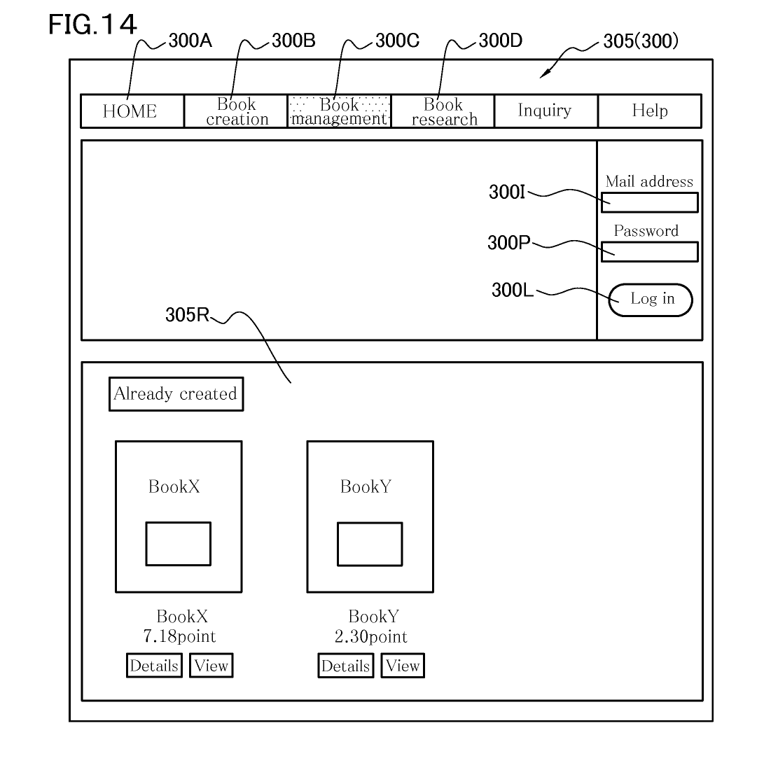

The browsers 45WB and 45WB′ are stored in the terminal device 4, so that if any one of them is executed, the site 300 can be displayed on the display portion 47. For example, the main page 301 of the site 300 (see FIG. 10) displays a list of digital books created recently as What's New, while a book management page 305 (see FIG. 14) displays in a predetermined display region 305R a list of digital books created so far by the registered user (logged-in user) who has logged in to the site 300. The digital books listed on the page of the site 300 have the corresponding reading buttons (buttons for reading) indicated to display them, so that if predetermined user operations are performed on the input portion 48 of the terminal device 4 to select any one of the reading buttons, the corresponding digital book such as shown in FIG. 8 can be displayed on the screen of the display portion 47.

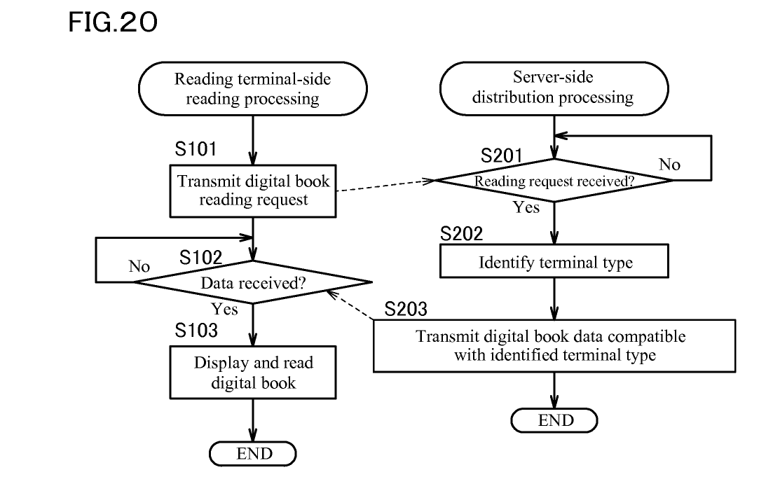

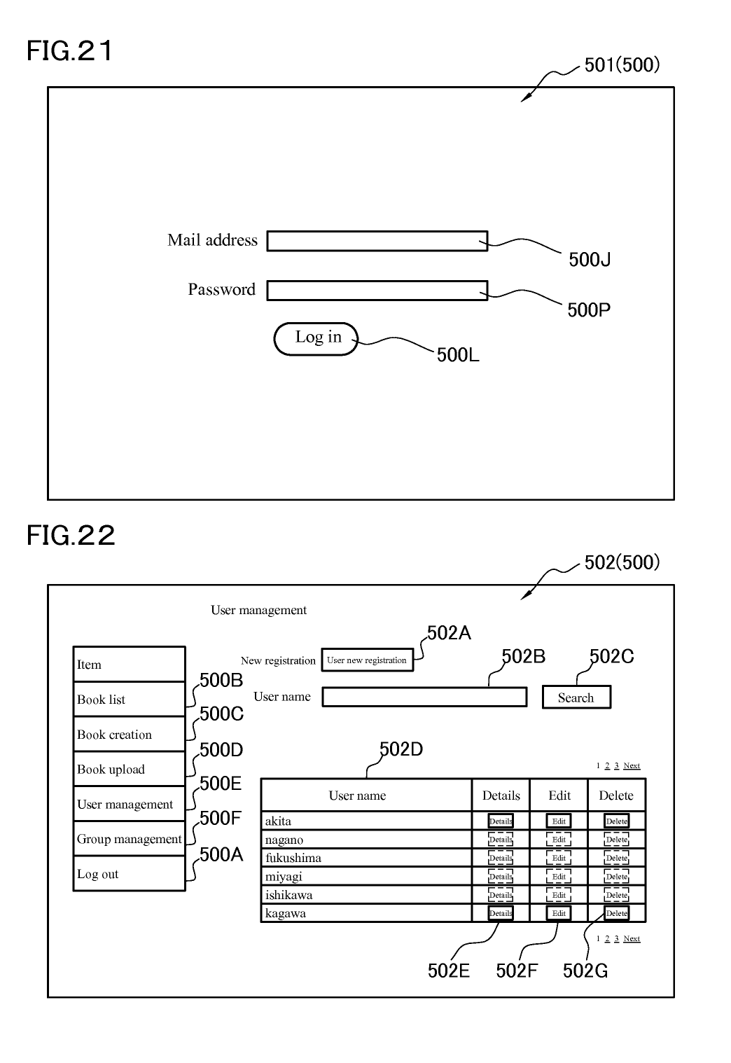

The following will describe digital book reading processing with reference to flowcharts shown in FIGS. 20 and 21.

In the embodiment, if the user performs predetermined operations (to-be-read book specification operations) on the input portion 48 of the terminal device 4 to specify a digital book to be read, processing (digital book distribution means) such as shown in FIG. 21 is performed.

That is, first, the CPU 41 of the terminal device 4 wiredly or wirelessly transmits a reading request signal for the to-be-read digital book to the server 2 via the communication means 3 (S101: reading request signal transmission means). The reading request signal contains book identification information which identifies the digital book to be read and terminal-compatible identification information which identifies terminal-compatible image data that is compatible with the terminal type of the reading terminal device.

The CPU 21 of the server 2 wiredly or wirelessly receives (acquires) via the communication means 3 the digital book reading request signal transmitted by the terminal device 4 (YES in S201: reading request signal acquisition means). The CPU 21 of the server 2 having received the reading request signal identifies a digital book to be read, specifically the data 250 of the digital book specified as a reading target based on the book identification information contained in this reading request signal (S202: reading book identification means). Furthermore, the image data specified as the terminal-compatible image data compatible with the distribution source reading terminal device is identified from among the terminal-compatible image data in the data 250 of the identified digital book based on the terminal-compatible image specification information contained in the reading request signal (reading terminal type identification means). Then, distribution book data 250′ containing the identified terminal-compatible image data is distributed (S203). In this case, the CPU 21 reads the terminal-compatible image data (any one of “AP”, “AA”, and “AI”) compatible with the type of the identified reading terminal device, the character data “AM”, the display position data “AN”, and the display control data “AC” (reading control program) among the data 250 of the identified digital book “A” from the storage device (digital book storage portion and reading control program storage portion) 25 and wiredly or wirelessly transmits (distributes) them as distribution book data 250′ to the terminal device 4 from which the received reading request signal is transmitted.

If having transmitted the reading request signal wiredly or wirelessly, the terminal device 4 enters a standby state to wait for receiving the distribution book data 250′ corresponding to the reading request signal. Then, if the distribution book data 250′ transmitted from the server 2 is received (YES in S102: distribution book data reception means), the various kinds of data contained in the distribution book data 250′ are read by the reading-purpose program 45E (45WB and 45F, 45AP and 45F′), to display a digital book “A” in such a form as shown in FIGS. 8 and 9.

Specifically, if the reading-purpose program 45E executes the display control data (Flash data) 250C, various kinds of set files are read including the image files 250K (see FIG. 3C) of the page display-purpose data 250L compatible with the type of the terminal device 4. The set files include the display control program that forms on the screen of the display portion 47 a book reading-purpose book content display frame 200 such as shown in FIGS. 8 and 9. If this control program is read and executed, the page display portion 201 which displays to-be-read pages of the digital book and the operation button display portion (operation image display portion) 202 having the operation buttons (operation images) 200a to 200i used to perform predetermined command operations on the digital book displayed in the page display portion 201 are formed at predetermined positions and in predetermined display modes on the screen of the display portion 47. Furthermore, the page number information 250l of the page to be read is identified to identify an image file compatible with the identified page number information 250l (image file having the file name of the identified page number) 250K, so that the page to be read is displayed in the page display portion 201 based on its page image file 250K. Further, the set files include an operation control program that conducts control corresponding to predetermined operations, if performed, into the book content display frame 200. This control program conducts control corresponding to various kinds of operations such as, for example, page movement expansion operations, keyword search operations, search keyword spotlighting. If the image files 250K of the page display-purpose data 250L are read, the operation control program recognizes the last page number information 250l (largest page number) and reflects it on control. For example, if the last page is being displayed, operations to move to the next page are not accepted.

Further, in the embodiment, when newly storing the produced digital book data 250 in the storage device 25, the identification information “AU” of the user who has produced it is stored in it in condition where it is correlated with this digital book data 250. It is thus possible to display a list of the digital book data 250 produced by the same user as shown in FIG. 14, for example.

Next, a description will be given of a system 1L shown in FIG. 1B in which the terminal devices 4 and the server 2 are connected to each other via internal communication means 3L (the communication means 3) such as a local network like an in-house LAN. The same reference symbols are given to the same components in the system 1I, and repetitive description on the same components will be omitted.

The digital book provision system 1L is also based on the assumption that its user is a registered user who has registered his/her own user information in the server 2. However, the user information of only a management user having the later-described user registration authority can be registered. In the system 1L, on a log-in page 501 of a site 500 shown in FIGS. 21 to 27, predetermined log-in information in accordance with user information registered beforehand is input into input columns 500J, 500P by using the input portion 48. Then, a long-in button (operation screen) 500L is selected by the input portion 48 to complete log-in operations. In this case, the log-in information is also a “mail address” and a “log-in password”. Data 259 used to display the site 500 is stored in the storage device 25 beforehand (see FIG. 3A).

Pages 501 to 507 shown in FIGS. 21 to 27 can be read only on the terminal device 4 connected to the server 2 via internal communication means 3L (communication means 3).

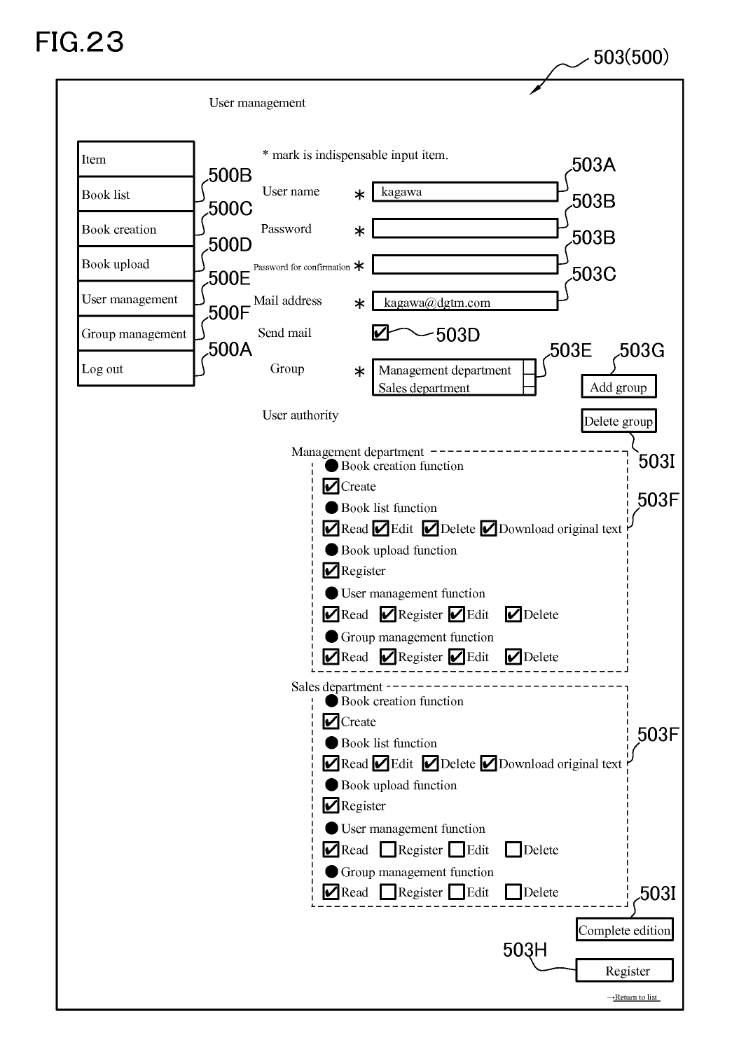

A description will be given of registration of the user information. To register the user information, first the management user having the user registration authority logs in to then select an operation button (operation screen) 500E on each of the pages 502 to 507 of the site 500 shown in FIGS. 22 to 27 by using the input portion 28, displaying a user management page 502 shown in FIG. 22. Then, the input portion 28 is used to select a user new registration button (operation screen) 502A to display a user registration page (which may be referred to also as authority setting page) 503 shown in FIG. 23. Then, the input portion 28 is used to input necessary information into the input columns 503A to 503E on the user registration page 503 to further check some of check boxes for authority setting which are compatible with various kinds of authorities of the authority setting column 503F and select a new registration button (operation screen) 503H. Thus, the server 2 accepts the input information (input information and authority settings into the input columns 503A to 503E), to complete user registration (authority setting means). The thus input user information is stored by the CPU 21 in the server 2 as registered user information 255 in the storage device (registration user storage device) 25.

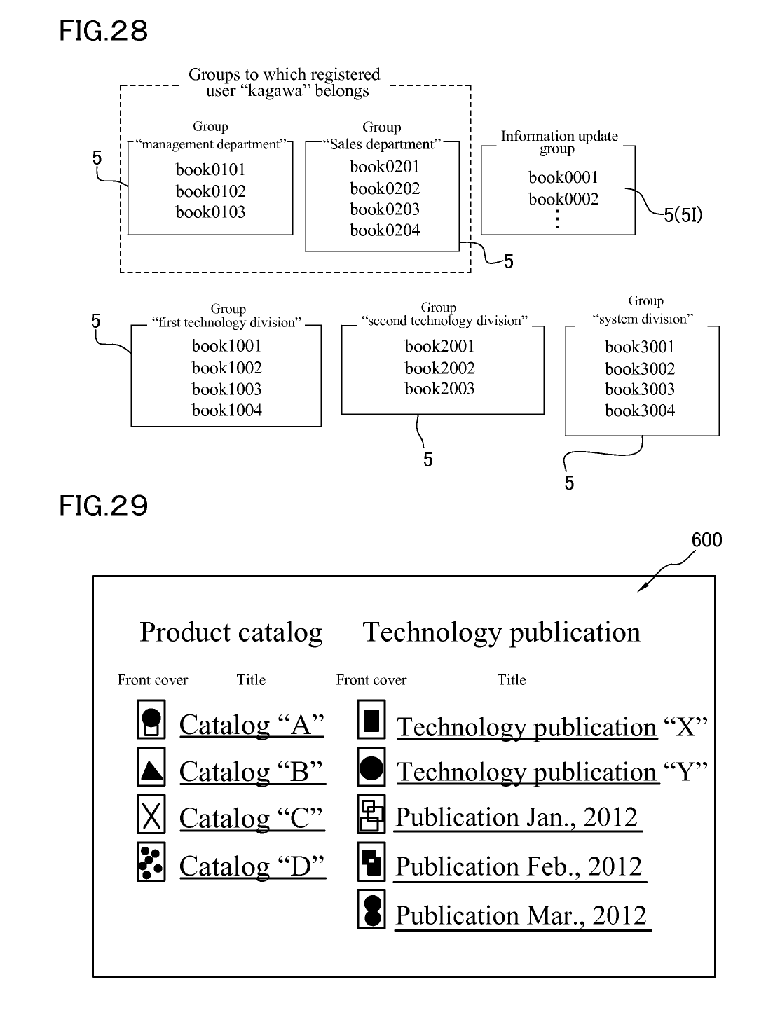

Further, in the user registration processing, user registration is completed by selecting one or a plurality of groups 5 (see FIG. 28) to which the user belongs for this user to be registered by using the input portion 28. In this case, the CPU 21 in the server 2 registers the selected one or plurality of groups 5 as a group 5 to which this user belongs (group registration means). Each of the groups 5 has a defined range in which authorities can be set for the belonging user, so that authorities can be set for each belonging registered user within this defined authority range. The authorities to be set for the registered user refer to predetermined authorities related to book usage for group-use book groups of the groups 5 to which the registered user belongs.

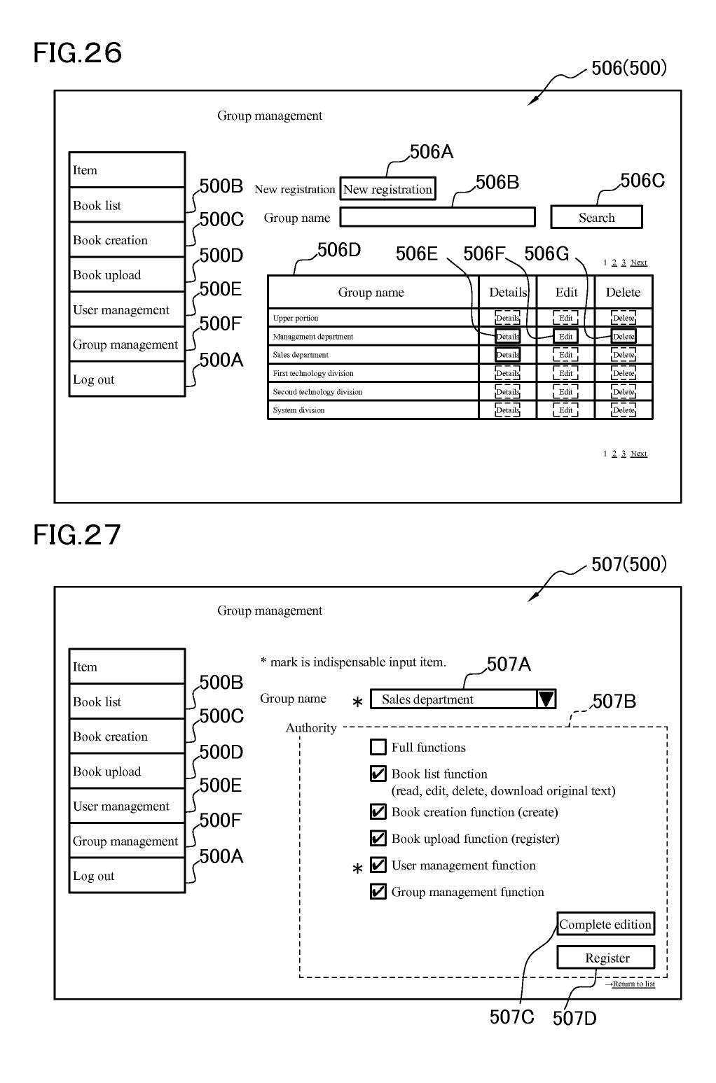

Those groups 5 can be newly created only by the management user having the later-described group registration (group creation) authority. Specifically, in new registration of the group 5 (new creation), the management user having the group registration (group creation) authority longs in and then selects an operation button (operation screen) 500G on each of the pages 502 to 507 of the site 500 shown in FIGS. 22 to 27 by using the input portion 28, to display a group management page 506 shown in FIG. 26. Then, a group new registration button (operation screen) 506A is selected using the input portion 28 to display the group registration page 507 shown in FIG. 27. Then, the input portion 28 is used to directly input a group name into the input column 507A on the group registration page 507 and also check authority types (hereinafter referred to as settable authorities) which enable setting authorities of the check boxes compatible with the authorities in the authority setting column 507B and then select the new registration button (operation screen) 507D. Thus, the server 2 accepts those inputs (group name and setting state of settable authorities), to complete registration of the groups 5 compatible with the input information (group creation means and settable authority setting means). In this case, the input information is stored by the CPU 21 in the server 2 as group information 257 in the storage device (group storage device) 25.

In the group registration processing, the settable authorities that can be correlated with the group 5 refer to those to define an authority range which can be set by the registered user in the group 5, so that finally on the user registration page 503, various authorities are individually set within the authority range set for the group 5 for each of the registered users belonging to the group 5.

The group registration processing and group registration processing performed at the server 2 can be carried out on the terminal device 4 on the assumption that the management user having the user registration or group registration authorities at the terminal device 4 has logged in.

The settable authorities (authority range) as correlated with the group 5 are used to determine whether to permit setting of book list function-related authority, group management function-related, book upload function-related authority, user management function-relatedauthority, and group management function-related authority and individually set for each of the groups 5, as shown in FIG. 27.

In each of the groups 5, only the permitted authorities can be added to the belonging registered user, and unpermitted authorities cannot be added to the belonging registered user. That is, only those authorities permitted in each group 5 are displayed in the authority setting column 503F on the user management page 502 shown in FIG. 22, and authorities not permitted in each group 5 are not displayed and cannot be set. Those unpermitted authorities need not always be hidden but only need to be disabled to be set.

The book list function refers to a function which reads, edits, and deletes a book and downloads the original image file (original text) 250Q of this book. In the system 1L, if an authority that can be set to the book list function (an authority corresponding to “book list function” in the authority setting column 507B shown in FIG. 27) is given, the book list button 500B can be selected (in this case, validated) by the input portion 48 to enable page transition to the book list display page 504. Then, on the page 504, conditions including keyword search can be narrowed down to display a list of digital books based on those operations. If a book reading authority (authority corresponding to “Read” of the book list function in the authority setting column 503F in FIG. 23) is given, one of titles (links) is selected by the input portion 48 from the list-displayed digital books to perform processing to distribute the selected book (FIG. 20) and display the distributed digital book on the display portion 47 as shown in FIGS. 8 and 9 so that it can be read. If book edition and deletion authorities (those compatible with “Edit” and “Delete” in the book list function in the authority setting column 503F in FIG. 23) is given, one of the listed digital books is selected to enable edition and deletion of the specified digital book.

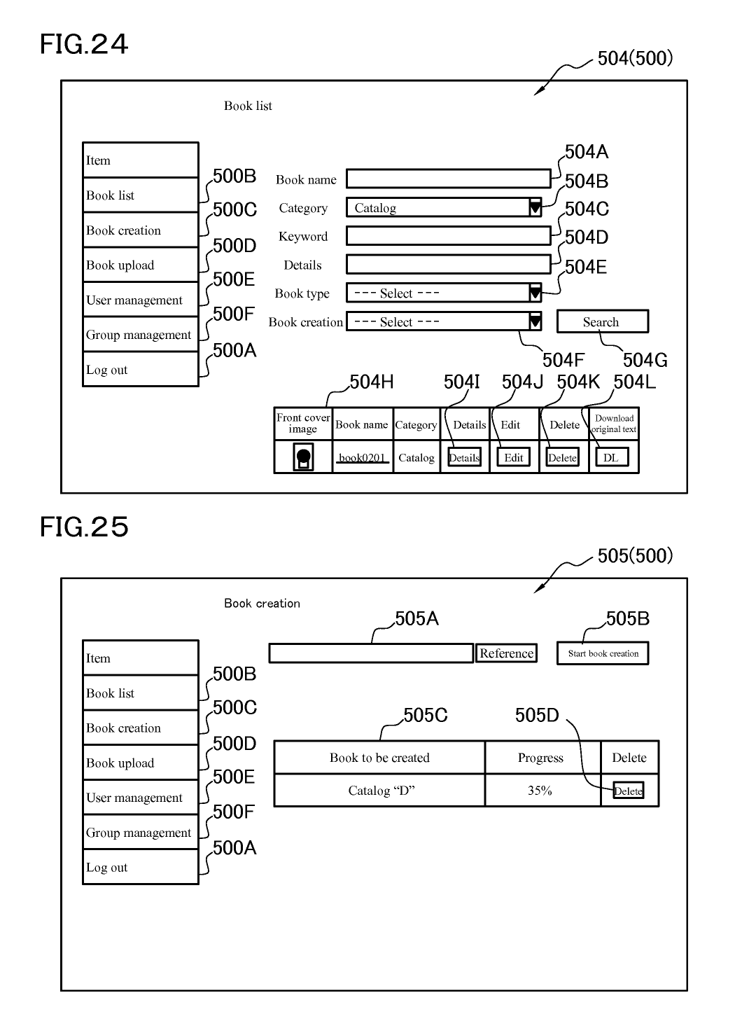

In this case, as shown in FIG. 24, for example, a book name, a category, a keyword, details, a book type (right side closing or left side closing), and a book creation (the system creates the book or not) are input into the necessary one of the input columns 504A to 504F on the page list display page 504 by using the input portion 48, to narrow down books compatible with the input information, so that the digital books given by the narrow-down operations are displayed in a list in the list display column 504H. Then, the input portion 48 is used to select one of the detail button 504I, the edition button 504J, and the deletion button 504K which is compatible with each of the listed digital books, to make the shift to a page on which processing is performed corresponding to the selected buttons 504I, 504J, and 504K.

If the detail button 504I is selected, a page appears on which the book information corresponding to the button is displayed and edited. However, to edit the detail information, it is necessary to set beforehand an edition authority (authority compatible with “Edit” of the book list function in the authority setting column 503F in FIG. 23).

If the edition button 504J is selected, the data 250 of a book compatible with this button can be directly edited. For example, it is possible to replace the image files 250K of each page and edit the information 250B. However, to edit the information, it is necessary to set beforehand an edition authority (authority compatible with “Edit” of the book list function in the authority setting column 503F in FIG. 23).

When the original text download button (DL button) 504L is selected, an original image file (original text) 250Q compatible with the button is downloaded to read the corresponding software, enabling editing it. After the edition, on the digital book creation page 505 in FIG. 25, the digital book creation function utilizing FIG. 18 can be utilized to create data 250 of the digital book based on the post-edition original image file 250Q and store it in the storage device 25 in the server 2. However, to download the original image file (original text) 250Q, it is necessary to set beforehand an authority for the downloading (an authority of “Download original text” of the book list function in the authority setting column 503F in FIG. 23). Further, to create a digital book (data 250), it is necessary to set beforehand an authority for digital book creation (authority compatible with “Create” of the book list function in the authority setting column 503F in FIG. 23).

If the deletion button 504K is selected, the data 250 of a book compatible with the button is deleted from the storage device 25 in the server 2. However, to delete the data, it is necessary to set beforehand an authority for edition (authority compatible with “Delete” of the book list function in the authority setting column 503F in FIG. 23).

The book creation function refers to a function to create the data 250 of a digital book from the original image file 250Q by utilizing the digital book creation processing in FIG. 18. In the system 1L, if an authority that can be set to the book creation function (“book creation function” in the authority setting column 507B shown in FIG. 27) is given, the book list button 500C can be selected (in this case, validated) by the input portion 48 to enable page transition to the book list display page 505. Then, if the registered user is given the book creation function authority (authority compatible with “Create” of the book creation function in the authority setting column 503F in FIG. 23), the user can upload the original image file 250Q on the page 505 (S1 and S2 in FIG. 18) and create a digital book based on the uploaded original image file 250Q.

In this case, as shown in FIG. 25, the input portion 48 is used to specify the original image file 250Q in the original image file specification column 504A on the book creation page 505 (S1 in FIG. 18) and further select a book creation start button 505B so that the specified original image file 250Q may be accepted by the server 2 (S2 in FIG. 18), performing digital book creation processing to convert into the data 250 of the digital book in accordance with the subsequent processing in S3 in FIG. 18. A situation of digital book creation (progress) is displayed in the creation book display column 505C. To delete a digital book already created or being created, the deletion button 504K is selected by the input portion 48 to delete the data 250 of the book corresponding to the button from the storage device 25 in the server 2.

The book upload function refers to a function to register the data 250 of a digital book already created to the storage device 25. In the system 1L, if an authority that can be set to the book upload function (“book upload function” in the authority setting column 507B shown in FIG. 27) is given, the book list button 500D can be selected (in this case, validated) by the input portion 48 to enable page transition to a book upload page (not shown). Then, if the user is given an authority of the book upload function (authority compatible with “Register” of the book upload function in the authority setting column 503F in FIG. 23), the user can specify the data 250 (or folder having it) of an already created digital book on the page 505 and then select the upload start button (not shown), to store the specified digital book's data 250 in the storage device 25 in the server 2.

The user management function refers to a function which reads, edits, and deletes the user information (including belonging group 5 and set authorities) of a registered user and registers a new user. In the system 1L, if the user management function settable authority is given, the user management button 500E can be selected (In this case, validated) by the input portion 48 to perform page transition to the user management page 502 in FIG. 22. On the page 502, a registered user's list display column 502D is displayed. By inputting a user name or part of it into the input column 502B and selecting the search button 502C, users to be list-displayed can be narrowed down.

If a reading authority of the user management function (authority compatible with “Read” of the user management function in the authority setting column 503F in FIG. 23) is set beforehand, the detail button 502E compatible with list-displayed users (all of or some of users or only a user himself/herself) can be selected (validated). In this case, only the user engaging in registration can perform selection who belongs to a group 5 in which the reading authority of the user management function is set among the groups 5 to which the user himself/herself belongs. If any one of them is selected by the input portion 48, a page similar to the page 503 shown in FIG. 23 appears, so that the user information (registered user information) 255 of the user compatible with the button can be read. However, nothing can be input or edited in the input columns 502A to 502F.

If an edition authority of the user management function (authority compatible with “Edit” of the user management function in the authority setting column 503F in FIG. 23) is set beforehand, the edition button 502F compatible with list-displayed users (all of or some of users or only a user himself/herself) can be selected (validated). In this case, only the user engaging in registration can perform selection who belongs to a group 5 in which the edition authority of the user management function is set among the groups 5 to which the user himself/herself belongs. If any one of them is selected by the input portion 48, the page 503 shown in FIG. 23 appears, so that the input columns 502A to 502F can be edited by the input portion 48. By further selecting the edition completion button 503I, the edited contents can be fixed to update the user information (registered user information) 255. In this case, the registration button 503H is invalidated so that it cannot be operated.

If a deletion authority of the user management function (authority compatible with “Delete” of the user management function in the authority setting column 503F in FIG. 23) is set beforehand, the deletion button 502G compatible with list-displayed users (all of or some of users or only a user himself/herself) can be selected (validated). In this case, only the user engaging in registration can perform selection who belongs to a group 5 in which the deletion authority of the user management function is set among the groups 5 to which the user himself/herself belongs. If any one of them is selected by the input portion 48, the registered user (registered user information 255) compatible with the selected button is deleted.

If the registration authority of the user management function (authority compatible with “Register” of the user management function in the authority setting column 503F in FIG. 23) is set beforehand, selection of the user new registration button 502A is permitted (validated), so that if it is selected by the input portion 48, as described above, a new user (newly registered user information 255) can be registered on the page 503 shown in FIG. 23. The group 5 for a new user can be set by selecting the group addition button 503G in condition where at least one of the groups (all or some of the groups) 5 list-displayed in the group display column 503E so that the selected group 5 may be the user belonging group 5. In this case, the belonging group 5 can be selected from among only those groups to which the registration authority of the user management function is set of the groups 5 to which the user engaging in registration himself/herself belongs. Then, if the belonging group 5 is set, the authority setting column 503F used to set an authority in each of the belonging groups 5 is displayed for each of the belonging groups 5 to enable setting the authorities for each of the belonging groups 5. To decrease the number of the belonging groups 5, the groups 5 to be deleted can be selected from among all the groups 5 list-displayed in the group display column 503E and the group deletion button 503G can be selected. Thus, the groups 5 are excluded from the belonging groups 5 and the authority setting column 503F of those groups 5 is also erased. In this case, the edition completion button 503I is invalidated so that it cannot be operated.

The group management function refers to a function which reads already registered (created) groups 5, those groups 5 group information (including group names and settable authorities (authority range) which can be correlated with the groups 5), edits and deletes the group information, and registers anew group 5. In the system 1L, if the settable authority of the group management function is given, selection of the group management button 500F by the input portion 48 is permitted (in this case, validated) to enable page transition to the group management page 506 in FIG. 26. On the page 506, the list display column 506D of the registered groups 5 is displayed. By inputting the group names or some of them into the input column 506B and selecting the search button 506C, the groups 5 to be list-displayed can be narrowed down.

If the reading authority of the user management function (authority compatible with “Read” of the user management function in the authority setting column 503F in FIG. 23) is set beforehand, selection of the detail button 506E compatible with the list-displayed (all or some of the groups) 5 is permitted (validated). In this case, only the group to which the reading authority of the group management function is set can be selected from among the groups to which the user engaging in registration himself/herself belongs. If any one of them is selected by the input portion 48, a page similar to the page 507 shown in FIG. 27 appears to enable reading the group information 257 of the user compatible with the button. However, both the input columns 507A and 507B cannot be input and edited.

If the edition authority of the user management function (authority compatible with “Edit” of the user management function in the authority setting column 503F in FIG. 23) is set beforehand, selection of the edition button 506F compatible with the list-displayed groups (all or some of the groups) 5 is permitted (validated). In this case, only the group 5 to which the edition authority of the group management function is set can be selected from among the groups 5 to which the user engaging in registration himself/herself belongs. If any one of them is selected by the input portion 48, the page 507 shown in FIG. 27 appears, so that it is possible to select the group 5 to be edited by switching in the input column 502A and edit (change) the authority set state in the authority setting column 502F for the selected group 5 by using the input portion 48. Besides, the edition completion button 503C can be selected to fix the edited contents and update the group information 257. In this case, the registration button 503D is invalidated so that it cannot be operated.

If the deletion authority of the user management function (authority compatible with “Delete” of the user management function in the authority setting column 503F in FIG. 23) is set beforehand, selection of the deletion button 507G compatible with the list-displayed groups (all or some of the groups) 5 is permitted (validated). In this case, only a group 5 to which the deletion authority of the group management function is set can be selected from among the groups 5 to which the user engaging in registration himself/herself belongs. If any one of them is selected by the input portion 48, the group 5 (group information 257) compatible with the selected button is deleted.

If the registration authority of the group management function (authority compatible with “Register” of the group management function in the authority setting column 503F in FIG. 23) is set beforehand, selection of the group new registration button 506A is permitted (validated), so that by selecting it by the input portion 48, the new group 5 can be registered (created) on the page 507 shown in FIG. 27 as described above.

In each of the groups 5, as shown in FIG. 28, at least one digital book of the digital books stored in the storage device (digital book storage portion) 25 is correlated as a group-use book group, so that a relationship of the correlation is stored as the group information 257 in the storage device (group-use book group storage portion) 25.

In the embodiment, the digital books (digital book data 250) created or uploaded by the book creation function (FIG. 18) and the book upload function and stored in the storage device 25 are correlated with the group 5 to which the registered user involved in creation or uploading (S10) and provide a group-use book group for those belonging groups 5 (group-use book group registration means). Further, in the embodiment, the digital books created or uploaded and stored in the storage device 25 are correlated as a group-use book group for the group to which the digital book creation authority is set validly among the groups 5 to which the registered user involved in creation or uploading belongs.

Further, in the embodiment, in each of the groups 5, the predefined authorities which are set to the belonging registered users include authorities related to use of books for the group-use book group of the group 5. Then, in each group 5, to the authorities which are set to the belonging registered user, an authority related to the corresponding group-use book group is set for each of at least one group to which this registered user belongs. In this case, on the user registration page (authority setting page) 503 in FIG. 23, the authority setting column 503F is displayed for each belonging group 5, so that in the group-specific authority setting column 503F, authorities are set in the respective groups.

In the embodiment, in each group 5, the predefined authorities which are set to the belonging registered users include at least the reading authority (authority compatible with “Read” of the book list function in the authority setting column 503F in FIG. 23), which means that the authority exists as an authority capable of being setting the reading authority and does not means that it can set always. If the digital book reading authority is given in all of the groups 5 to which the registered user belongs, the group-use book groups of all of those belonging groups 5 can be read. Further, even if belonging to the group 5, the registered user cannot read the group-use book group of this group 5 unless the user is not given the reading authority in this group 5. The group-use book group of the group 5 to which the user does not belong cannot be read irrespective of the setting of the reading authority, and also the reading authority cannot be set to it.

Further, in the embodiment, the predefined book information related to the digital books and stored in the storage device 25 is disclosed and displayed on a predefined book information disclosure site 600 (book information disclosure page: see FIG. 29) which can be read through the communication means 3. In the embodiment, site data 950 necessary to disclose and display the site 600 is stored in a storage device 95 of a page disclosure-use terminal device 9 which connects to the communication means 3, to disclose the site 600 on the communication means 3 based on its site data 950, as shown in FIG. 31. And, as shown in FIG. 28, the groups 5 include an information update group 51 for updating book information to be displayed and disclosed on this site 600, so that the book information displayed on this site 600 is updated on the basis of the book information for each book in the group-use book group correlated with this group 51 (information update means).

The site data 950 is made up of a display program that defines a display layout of the book information disclosure site 600 and displays book information, which is display element data, of each digital book at predetermined positions on it, display element data (display elements in the figure) of each digital book displayed by the display program, and an update program that updates the display element data. The book information disclosure site 600 is displayed on the communication means 3 and, on each reading terminal device 4 connecting to the communication means 3, can be read in condition where the site 600 is displayed on the screen of the display portion 47 according to the display program of the site data 950.

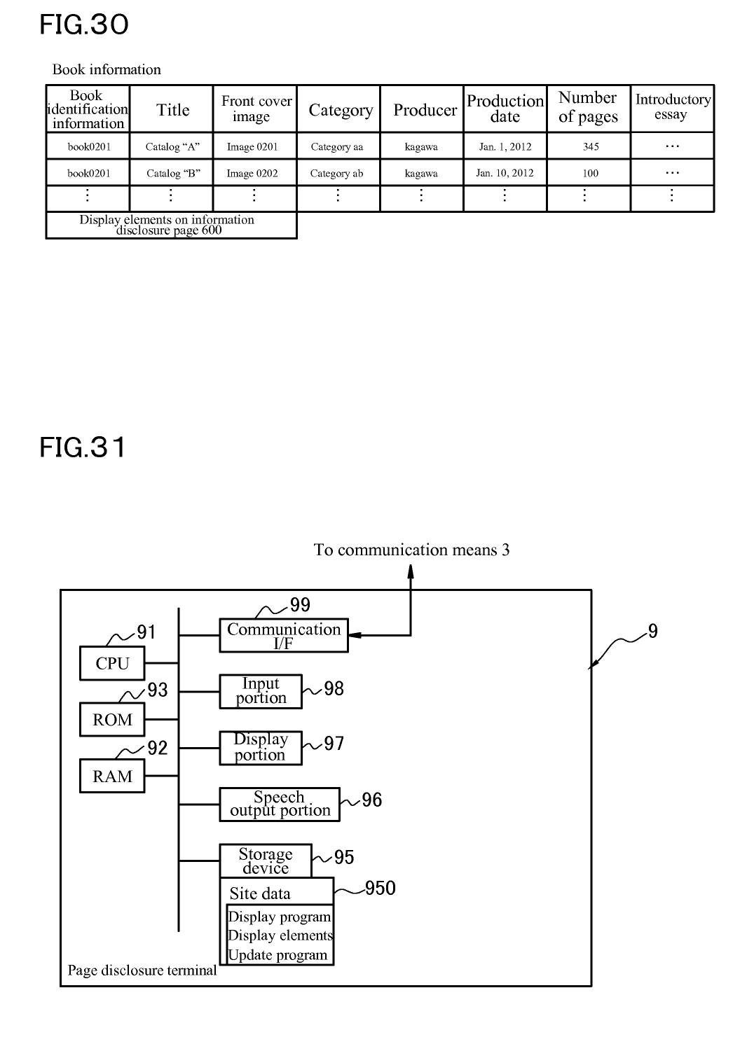

The display element data (book information) of the embodiment is a predefined data of the book information 250B of each digital book 250 belonging to the group-use book group of the information update group 51 as shown in FIG. 30. The contents of the book information 250B can be changed, so that the contents, if changed, are reflected on the book information disclosure site 600.

Further, in the embodiment, if at least one information update group 51 is included, the book information disclosure site 600 is correlated with each information update group 51, so that it is stipulated that the displayed contents of the corresponding book information disclosure site 600 may be updated on the basis of the display element data of each information update group 51.

The terminal device 9 has a known configuration in which a storage device 95 including an ROM 93, an RAM 92, and a hard disk drive (HDD) and a known communication interface 99 for network connection are connected to a CPU 91 and, further, an input portion 98 including a keyboard, a mouth and other pointing devices, a display portion 97 such as a liquid crystal display, and a speech output portion 96 such as a speaker are connected thereto.

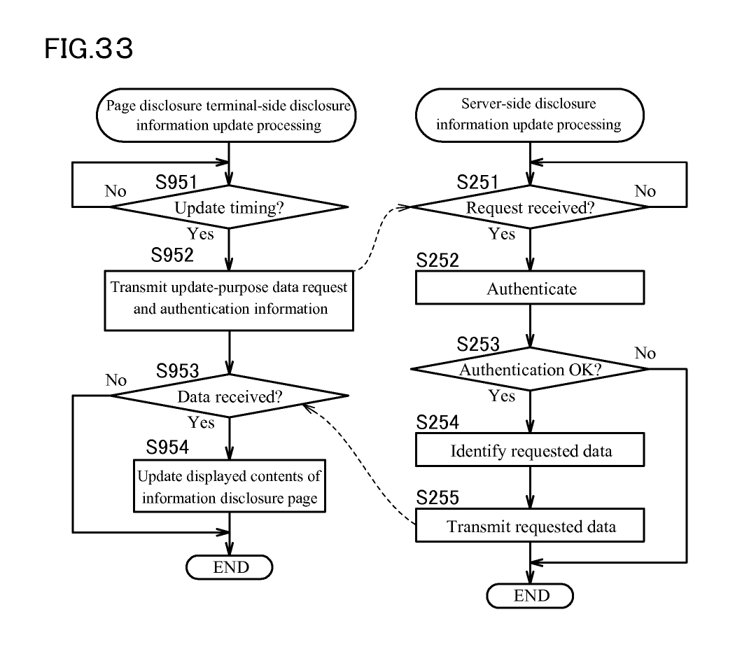

The following will describe processing to update book information of each digital book disclosed and displayed on the book information disclosure site 600 with reference to FIG. 33.

First, in S951, the CPU 91 decides whether predetermined timing to update the book information disclosure site 600 has come. The update timing can be set to an once-a-month predetermined time point in a predetermined month or a time point when an external update signal is received. If it is decided that the updating timing has come, in S952, the CPU 91 transmits a signal to request for book information disclosure site 600 update-purpose data to the server 2 via the communication means 3. The update-purpose data refers to display element data in the digital book 250 of the information update group 51. Further, along with the request signal, authentication information for the terminal device 9 is also transmitted.

In this case, if having received the request signal (YES in S251), the CPU 21 in the server 2 starts authentication processing (S252) based on the authentication information received along with it and, if authentication proves OK (YES in S253), identifies the requested update-purpose data (display element data) (S254) and transmits it to the terminal device 9 which requests for the identified data. If authentication proves NG (NO in S253), no data is transmitted to end the processing.

In S953, the CPU 91, if having received the requested update-purpose data (display element data), updates the display element data of the site data 950 stored in a storage device 95 based on the data received in S954, ending the processing. Thus, when subsequently displaying the book information disclosure site 600 on the terminal device 4, the updated contents of the book information disclosure site 600 are displayed. For example, if a front cover of the digital book 250 referred to as the catalog “A” in FIG. 30 is already updated in the server 2, the image of the front cover of the catalog “A” on the book information disclosure site 600 in FIG. 29 is updated.

In the embodiment, when requesting for the display element data (S952), by requesting for all the display element data in all the digital books 250 in the information update group 51 and overwriting all the display element data of the site data 950 stored in the storage device 95 with the received data, updating is performed.

Although there has been hereinabove described the embodiment of the invention, it should be appreciated that it is just an example and the invention is not limited thereto and, accordingly, any and all modifications etc. can be performed by those skilled in the art without departing from the gist of the invention.

For example, although the embodiment has both of the systems 1I and 1L, the digital book provision system 1 of the invention may be assumed only to be the system 1I or the system 1L. A plurality of the servers 2 may be provided and the server 2 constituting the system 1I and the server 2 constituting the system 1L may be different from each other.

Further, the user registered in the server 2 may be a person who reads books via the reading terminal device 4 or the reading terminal device itself.

Further, if the terminal device 4 for reading digital books comes in one type, a configuration may be employed in which the page display-purpose data 250L is not prepared for each terminal device type.

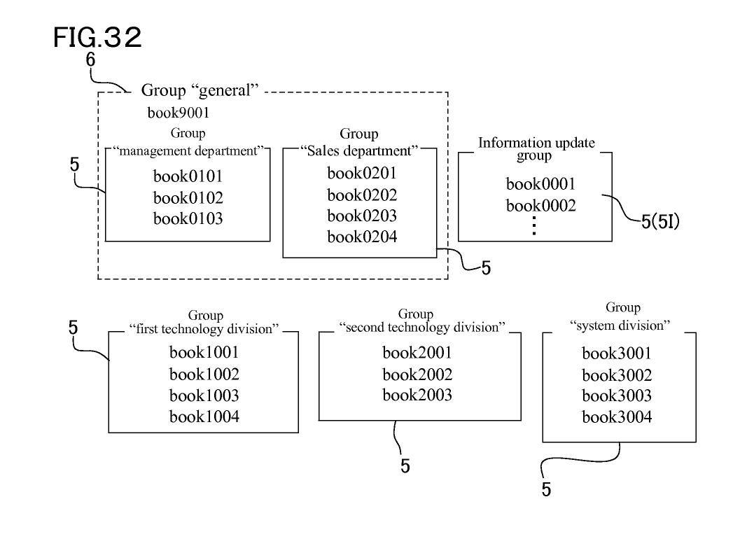

In terms of group setting, as shown in FIG. 32, a group may belong to another group, that is, a large group having at least one small group may be made settable. It is thus possible to cause all the users belonging to a group to belong collectively to another group.

Further, groups can be set between one terminal device 4 and another which connect to the server 2 via the communication means 31 such as the Internet. It is thus possible to set groups, for example, over companies. Specifically, a digital book management system can be made up of a system to arbitrarily read and edit the books through authority setting, for example, one customer may be set so that it can only read only one digital book group and another customer may be set so that it can read and edit this digital book group and another digital book group.

Thus, the digital book provision system of the invention enables group setting to perform functions as a digital book management system.

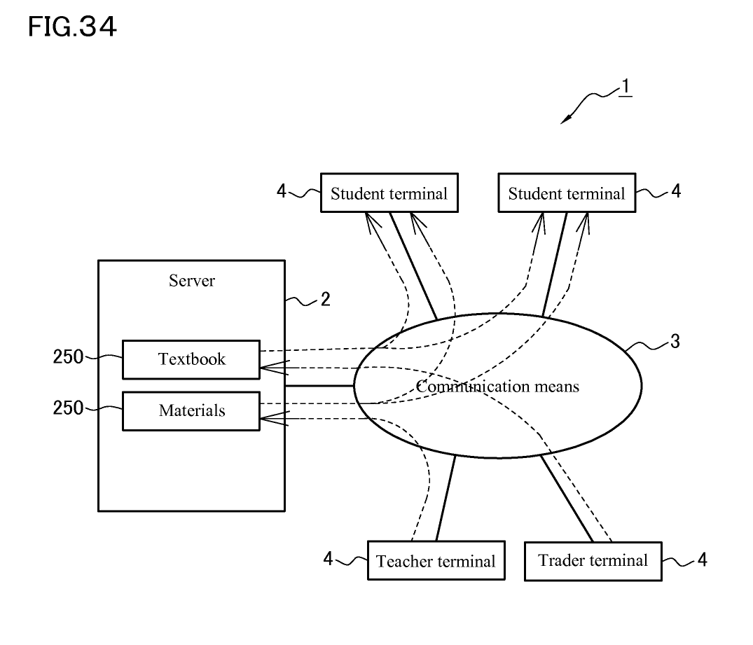

Further, FIG. 34 shows an example where the digital book provision system 1 of the embodiment is introduced to a field of education such as a school or a cram school. The school has introduced the server 2 in the embodiment. The server 2 stores beforehand a textbook already created as a digital book from a textbook distributor so that it can be read at the terminal devices 4 of student. However, in class, not only the text book but also materials created respectively by a teacher may be used often, so that the teacher attempts to create them so that they may provide the original image file 250Q and, after the creation, uploads the digital book creation pages 304 to 505 to the server 2 to provide the digital book 250. It is thus possible to read the materials created by the teacher personally as a digital book in much the same way as the textbook at the terminal device 4 in the school during class. Further, it is also possible to read them on the terminal device 4 in a personal residence or a mobile terminal device 4K.

### DESCRIPTION OF REFERENCE NUMERALS

1 Digital book provision system
2 Server
25 Storage device
250 Data of digital book
251 User registration program
252 Digital book creation program
253 Digital book distribution program
3 Communication means
4 Terminal device
4P (4W, 4L, 4M) Personal computer
4K (4A, 4I) Mobile type terminal device
45 Storage device
45E Reading-purpose program

1. A digital book provision system for creating and distributing a digital book whose pages are each displayed on a reading terminal device by an image file prepared for each page and in which keyword search can be performed on the basis of search-purpose character data which indicates a character string to be drawn by using the image files, the digital book provision system comprising:
digital book creation means having:
file acceptance means that accepts incoming one image file as an original image file, each page of the image file being displayed in a predetermined page frame and enabling forming images and character strings on it when the file is read by predetermined software, the page frame containing mutually correlated original image data to display the images and the character strings of each of the pages in the page frame and original character data to indicate the character strings of each of the pages to be displayed on the basis of the original image data, and page settings being made to both of the original image data and the original character data;
book basic data generation means that divides image data of each of the pages in accordance with the page settings contained in the one original image file whose incoming is accepted into page-specific image files, generates a page image file group in which those image files are correlated with page number information based on the page settings and character data which indicates character strings of each of the pages to be displayed by the page-specific image files, and displays drawn contents of each of the pages in the form of inheriting a display layout and the page settings in the page frame in each of the pages at the time when the original image data whose incoming is accepted is read and displayed with the software by the page-specific image files to be generated; and
digital book storage means that stores and accumulates in a predetermined digital book storage portion the generated page image file group assumed to be page display-purpose data in the digital book and the generated character data assumed to be the search-purpose character data in the digital book in the form of correlating the data with each other; and
digital book provision means having: reading request signal acquisition means that acquires a reading request signal for the digital books accumulated in the digital book storage portion via communication means; and
digital book distribution means that, if the reading request signal is acquired, reads the page display-purpose data and the search-purpose character data which are compatible with the reading request signal from the digital book storage portion and distributes the data to the reading terminal device from which the reading request signal is transmitted and also reads from a predetermined reading control program storage portion a reading control program which enables reading in page units the image files of all the pages contained in the page display-purpose data in accordance with the page settings in the original image file and then distributes this program.

2. The digital book provision system according to claim 1, wherein
the book basic data creation means has:
file decision means that converts the files in a plurality of types of file formats in which the character data can be stored as correlated with the image data into acceptable files and decides whether the original image file whose incoming is accepted by the file acceptance means is the acceptable file;
file conversion means that, if it is decided that the original image file whose incoming is accepted is the acceptable file, uniformly converts the original image file into an image file having a predetermined file format in which the character data can be stored as correlated with the image data to convert the original image data into uniform post-conversion image data which displays each page's images and character strings in the shape of inheriting each page's display layout and the page settings at the time when the original image data is read by the software and displayed and also converts the original character data into uniform post-conversion character data inheriting the page settings and then creates one uniform post-conversion image file in which both of the data are correlated with each other;
character data extraction means that extracts the uniform post-conversion character data from the uniform post-conversion image file which is created;
image data extraction means that extracts the uniform post-conversion image data from the uniform post-conversion image file which is created; and
page display-purpose data creation means that divides the extracted uniform post-conversion image data into page-specific image files and creates a page image file group in which page number information based on the page settings is correlated with the each page's image files thus divided.

3. The digital book provision system according to claim 1, comprising:
a registered user storage portion that defines the reading terminal device or a person who reads via the reading terminal device or both of them as a reading user and stores at least one of the reading users as a registered user;
a group storage portion that provides at least one group to which the reading user can belong and, for each of the groups, stores at least one of the digital books stored in the digital book storage portion as a group-use book group; and
authority setting means that sets to the registered user a predetermined authority related to use of books for the group-use book group of the group to which the user himself/herself belongs.

4. The digital book provision system according to claim 3, wherein the authority setting means sets to the registered user the authority related to the compatible group-use book group for each of the at least one group to which the registered user belongs.

5. The digital book provision system according to claim 3, wherein
predetermined book information in a predetermined each of the digital books stored in the digital book storage portion is displayed and disclosed on a predetermined book information disclosure page on which books can be read via the communication means, and
the groups include an information update group in which the digital books whose book information is displayed on the book information disclosure page are correlated as the group-use book group, and
the digital book provision system comprising information update means that updates the book information displayed on the book information disclosure page based on the book information of the group-use book group of the information update group.

6. The digital book provision system according to claim 3, comprising group-use book group registration means that, if the digital book is newly created by the registered user by using the digital book creation means, stores the created digital book as the group-use book group of the group to which the registered user belongs in the group storage portion.

7. The digital book provision system according to claim 2, wherein
the page display-purpose data creation means is terminal-compatible image data creation means that, when creating the page image file group used to display each page of the digital book based on one image file which constitutes the uniform post-conversion image file extracted by the image data extraction means, creates each page image file belonging to the page image file as terminal-compatible image data compatible with the respective display standards of the plurality of types of reading terminal devices for each of the reading terminal devices,
the digital book storage means stores and accumulates each page's image file which is the page image file group and created as the terminal-compatible image data of each reading terminal device and stores and accumulates the uniform post-conversion character data extracted by the character data extraction means as search-purpose character data in the digital book in the digital book storage portion in condition where this data is correlated with the terminal-compatible image data,
the digital book provision means includes reading terminal type identification means that, if the reading request signal is acquired by the reading request signal acquisition means, identifies the type of the reading terminal device based on identification information that is contained in this reading request signal and can identify the type of the terminal device from which the reading request signal is transmitted, and
the digital book distribution means distributes to the reading terminal device from which the obtained reading request signal is transmitted the page image file group created as the terminal-compatible image data compatible with the type of the identified reading terminal device as the page display-purpose data of the digital book compatible with the reading request signal and also distributes the search-purpose character data in this digital book and, further, distributes a reading control program which enables reading the image file of the page image file group in page units in accordance with the page settings in the original image file.

8. The digital book provision system according to claim 2, wherein the digital book creation means includes protruding region image exclusion means that excludes an image data portion protruding over a predetermined display range in the uniform post-conversion image file created by the file conversion means to provide the image data in this display range.

9. The digital book provision system according to claim 1, wherein the plurality of types of reading terminal devices has different screen sizes specific to their types and the terminal-compatible image data creation means changes the image data extracted by the image data extraction means to a predetermined screen size for each of the plurality of types of reading terminal devices.

10. The digital book provision system according to claim 1, wherein if the original image file is uploaded based on predetermined user operations on a predetermined disclosure page, the file acceptance means accepts incoming this original image file.
